(19) United States
(12) Patent Application Publication
(10) Pub. No.: US 2001/0038612 A1
(43) Pub. Date: Nov. 8, 2001

(54) Automatic routing system for circuit layout

(76) Inventors: Darrell Vaughn, Dallas, TX (US); Marvin Karlow, Dallas, TX (US); Elizabeth Gurley Vaughn, Dallas, TX (US)

Correspondence Address: HOWISON, CHAUZA, HANDLEY & ARNOTT L.L.P, P.O. BOX 741715, DALLAS, TX, 75374-1715, US

(21) Appl. No.: 09/797,172

(22) Filed: Mar. 1, 2001

Related U.S. Application Data
(63) Continuation-in-part of application No. 09/410,009, filed on Sep. 30, 1999.

(51) Int. Cl. H04L 12/26

(52) U.S. Cl. 370/256; 370/248

(57) ABSTRACT

A method is disclosed for automatically planning the routing of circuit paths on a routing surface by defining a topology of the circuit paths according to input data for connections to be routed and respective routing constraints associated with the connections to be routed; creating the circuit paths for connections to be routed having associated routing constraints iteratively according to the defined topology of the circuit paths within each unit zone; evaluating the circuit paths for compliance with the respective routing constraints during the step of creating the circuit paths; and saving data describing the circuit paths. In an alternate embodiment, a method is disclosed for planning the routing of circuit paths on at least one routing surface by creating a pattern of traces on a routing surface from input data for connections in accordance with the trace creating algorithm; after creating less than all of the pattern of traces, analyzing an operational characteristic of traces subject to predetermined routing constraints of the created portion of the pattern of traces in the operating environment of the trace; comparing results of the analyzing step to a specification for the operational characteristic of the created portion of the pattern of traces; modifying the trace creating algorithm if the operational characteristic fails to satisfy the specification; and repeating the foregoing steps until the operational characteristic satisfies the specification.

### BACKGROUND OF THE INVENTION

The routing of numerous point-to-point paths along a surface between separated locations is an activity found in many fields for the transport of people, goods, information or other communications which can be modeled as the routing of paths on one or more surfaces. Generally, the space on the surface is limited for use by paths, in place by the available area, by objects on the surface or by rules regulating the use of the surface. One example of a typical path routing situation involves the transport of people or goods along established paths either by surface or by air transport, wherein the problem focuses on the density of traffic along the path or on obstacles to travel along established paths. A similar example in the communications field is the routing of telephone traffic or other electrical signals of varying density along limited pathways or circuits. Some situations, like those described above, can be modeled by routing paths in a region defined in three dimensions. Others are adequately modeled by regions defined in two dimensions, such as a planar surface or a set of parallel planar surfaces. A typical example of the latter is an electrical circuit implemented on a printed circuit board or other substrate and having one or more layers.

Printed circuit boards for electrical circuits heretofore have been routed by hand or by machine in order to confine all of the circuit paths to a single surface or to a small number of planar surfaces in order to minimize the size and weight of the circuitry required in a product and to make the circuitry as amenable as possible to automated manufacture. Confining the circuit paths to a two-dimensional surface presents several problems to the designer. First, because of the restriction to two dimensions, the paths must be arranged on the surface so that there is little or no overlap in paths, as the circuit paths are connected between a beginning point and an end point for each circuit. Second, the number of planar surfaces available for circuit paths must be kept to a minimum in order to keep the cost of reproducing the circuit within reasonable limits. Whether the circuit routing paths are arranged or produced by hand or by machine, the process of completing the routing for all of the circuits necessary in the product is a time consuming and tedious activity. In general, each circuit path must be routed one at a time from the beginning point to the end point. Although the routing of paths early in the project proceeds rapidly, as the density of paths accumulating on the surface increases, eventually the choice of possible routes for the circuit paths becomes quite limited by other paths already positioned or by other obstacles such as electrical and mechanical components supported on the surface. An example of a typical path routing problem in the prior art is shown in FIG. 1, where several point-to-point circuit connections are shown in dashed lines interconnecting terminals on each of three integrated circuit packages placed upon on a planar circuit board surface. Typically, however, all or most of the circuit paths are directed in either of two orthogonal directions, shown in solid lines, either horizontally or vertically along the board surface and, generally referenced to the edges of the board, wherein the board shape is typically rectangular.

In FIG. 1, there is shown a group of components interconnected by circuit paths shown as solid lines between terminals of the components denoted by darkened circles and intermediate terminals shown as small triangles. A component 10 has terminals 16 and 34 which connect to circuit paths 18 and 36, respectively. A component 12 has terminals 24 and 42 connected to circuit paths 22 and 40, respectively. A component 14 has a terminal 50 connected to a circuit path 48. Circuit path 18 connects to intermediate terminal 20 which is also connected to circuit path 22. Circuit path 36 connects to an intermediate terminal 38 which is also connected to circuit path 40 and to a circuit path 44. Circuit path 44 is connected to intermediate terminal 46 which is also connected to circuit path 48. Similarly, terminal 24 on component 12 is connected to intermediate terminal 28 along circuit path 26. Finally, intermediate terminal 28 is connected to terminal 32 along circuit path 30. The beginning and end points of each set of paths are shown connected by dashed lines. During routing, these dashed lines, point-to-point connections between respective terminals of the three components are decomposed into orthogonal paths shown as solid lines connecting the respective terminals on the components with intermediate terminals located at the junction of orthogonal paths. In this simple example, resolving the point-to-point paths into orthogonal components does not eliminate the path conflicts that usually arise when components having a plurality of terminals that are interconnected with each other. For example, in FIG. 1, the two circuit paths 22 and 36 are shown to cross each other and since both paths are intended to be placed on the same planar surface, one of the paths must be either re-routed or include a jumper across the other path with which it intersects on the planar surface. Such jumper, either in the form of a physical wire or in the form of a transition such as a via to another planar surface adjacent the planar surface of the circuitry on the diagram shown in FIG. 1. Thus, FIG. 1 illustrates one of the very basic problems of printed circuit board routing the path conflict problems. It will be further appreciated that the more complex the circuit and the smaller the surface available for circuit paths, the more difficult and tedious is the task of finding the solution to a circuit board routing problem.

In FIG. 2, there is shown a portion of a printed circuit board having a typical path maze formed by a partially routed surface. This portion of the circuit board shows several components mounted on the printed circuit board, wherein each of the components has several terminals which serve as connection points for circuit paths between the components. Of particular interest in the example shown in FIG. 2 is the pair of terminals labeled “A” and “B” respectively located on two of the components on the circuit board. Components involved in the interconnections that will be discussed include component 62 which includes terminal A and components 64, 66, 68 and 70. Component 70 includes terminal B. In this example, terminal A will be considered the beginning or origin terminal and terminal B will be considered the ending or destination terminal. Some of the terminals on these components are interconnected as shown by solid lines between the terminals on the respective components. However, the connections of interest are shown as dotted lines, which illustrate that at least three possible routes are available to connect terminal A with terminal B. For example, terminal A is connected along path 72 to a junction 73 with path 74 and proceeding from the junction 73 along path 72 to another junction 77, which joins paths 72, 76 and 78. This junction 77 is located below or beneath component 70. Path 78 is further connected to a junction 79, which includes paths 74 and 80. Junction 79 is connected to terminal B along path 80. Thus, terminal A is connected via paths 72, 78 and 80 to terminal B, representing one of the available three routes for the circuit connection of terminal A with terminal B.

Returning now to terminal A, terminal A may be connected along path 72 and at the junction 73 a path 74 may be routed around the circuit board until it meets a junction 79, which is adjacent component 70. Junction 79 is connected to terminal B along path 80. Thus, a second possible route that is available to connect terminal A with terminal B proceeds along paths 72, 74 and 80 to terminal B. Similarly, a third path is available by beginning at terminal A and proceeding along path 76 which loops around component 68 and travels along the board to junction 77, where it joins with path 78 and proceeds to junction 79 and path 80 to terminal B, representing the third available route for connecting terminal A with terminal B.

In FIG. 2, the dotted lines illustrate three possible paths through a maze of component and other circuit paths on the surface of a circuit board. Generally, the task of finding the best route in prior art routing systems consists of searching such a maze to find the shortest and most direct path for the circuit. Typically, a path is searched and the etch route determined in one process, one path at a time. The search in the maze can be performed by an individual by hand or by machine, generally involving a computer program that includes a search engine which evaluates the maze topology and finds a suitable path for connecting the two terminals of interest. The time to search the maze will increase as the density of paths increases and the number of available routes decreases. If no available route remains, an existing route must be selected and removed and then re-routed after the desired pair of terminals such as, in this example, terminals A and B, are routed. This substantially tedious process is then repeated for every path to be routed.

Further, if a selected route is subject to electrical interference, cross-talk or some other signal degradation due to parasitic impedances, etc., the problem may not be discovered until the circuit itself is energized and tested. A signal integrity algorithm, applied during the path routing may succeed in isolating a signal integrity problem, if one exists. However, applying such process during routing significantly slows down the search routine employed to locate the etch paths and may further reduce the number of available paths for other connections. Thus, FIG. 2 is seen to illustrate another very basic problem—the maze routing problem—of the routing of circuit paths on a planar surface.

The basic path conflict and maze routing problems illustrated respectively in FIGS. 1 and 2 are typically resolved in the prior art through circuit board routing techniques implemented by hand or by machine, which, when making every one of the connections in a complex circuit, one connection at a time, will be a tedious and time consuming process. Conventional machine routing systems, when equipped with suitable models for the surface, components and standardized circuit routing patterns that may be used in such a system, will still take considerable time to complete a routing project and will, in the end, most likely leave a number of paths un-routed because of the difficulty of searching an increasingly complex maze of circuit paths that have already been routed, and apparently leave no other alternatives for routing the last few paths. A significant limitation upon the prior art machine routing process then, is the need to consider each entire terminal-to-terminal path individually in determining where best to place it upon the planar surface. Other limitations of prior art routing schemes include non-uniform routing surface areas and inflexible node locations which generally remain fixed throughout the routing process. These limitations do not readily lend themselves to systematic analysis and thus impede the routing process. What is needed is a system and a method for routing the circuit paths that is not subject to such limitations.

### SUMMARY OF THE INVENTION

A method is disclosed for planning the routing of circuit paths on at least one routing surface, comprising the steps of defining a topology of the circuit paths on the routing surface according to input data for connections to be routed and respective routing constraints associated with the connections to be routed; creating the circuit paths for connections to be routed having associated routing constraints, iteratively within each one of a plurality of predetermined unit zones of the at least one routing surface wherein the plurality of predetermined unit zones are processed in a predetermined sequence, the circuit paths being created according to the defined topology of the circuit paths within each unit zone; verifying the circuit paths created, by evaluating the circuit paths for compliance with the respective routing constraints associated with the connections to be routed, during the step of creating the circuit paths; and saving data describing the circuit paths created for the at least one routing surface.

In an alternate embodiment, a method is disclosed for automatically routing circuit paths on at least one routing surface, comprising the steps of planning the routing of the circuit paths on the at least one routing surface to produce a routing plan; activating a routing engine to begin processing circuit path data retrieved from a routable segments file from an origin to an ultimate location and in incremental steps within each of a plurality of unit zones in sequence defined for the at least one routing surface to define an expanding virtual map of the routing plan such that all of the circuit paths defined by the routing plan between the origin and the extremities of the expanding virtual map are created; verifying, upon the completion of routing the circuit paths of each unit zone, that any routing constraint associated with a connection to be routed in the present unit zone in the routing plan satisfies the associated routing constraint; modifying the circuit path routing in the present unit zone if a routing constraint associated with a connection being verified in the previous step in the present unit zone does not satisfy the associated routing constraint; and advancing to the next unit zone.

In another embodiment there is described a method for planning the routing of circuit paths on at least one routing surface by creating a pattern of traces on a routing surface from input data for connections in accordance with the trace creating algorithm; after creating less than all of the pattern of traces, analyzing an operational characteristic of traces subject to predetermined routing constraints of the created portion of the pattern of traces in the operating environment of the trace; comparing results of the analyzing step to a specification for the operational characteristic of the created portion of the pattern of traces; if the operational characteristic fails to satisfy the specification, modifying the trace creating algorithm; and repeating the foregoing steps until the operational characteristic satisfies the specification.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a portion of a circuit layout that demonstrates a basic circuit routing problem of routing path conflicts;

FIG. 2 illustrates a portion of a circuit layout that demonstrates a basic circuit routing problem of selecting from alternate paths of a maze formed by other components and obstacles;

FIG. 3A illustrates a block diagram of the routing system of the present disclosure;

FIG. 3B illustrates a functional block diagram representation of the input block of FIG. 3A;

FIG. 4 illustrates a flow diagram for the operations of the analysis engine as shown in FIG. 3A;

FIG. 5 illustrates a diagram of alternate paths connecting three terminals;

FIG. 6 illustrates a diagram showing the resolution of the shortest direct paths connecting three nodes is resolved into orthogonal paths;

FIG. 7A illustrates a diagram of a memory type routing pattern FIG. 7B illustrates a diagram of a crossing type routing pattern;

FIG. 7C illustrates a diagram of a parallel type routing pattern; FIG. 7D illustrates a diagram of a parallel crossing type routing pattern;

FIG. 7E illustrates a diagram of a mixed parallel type routing pattern;

FIG. 7F illustrates a diagram of an S type routing pattern;

FIG. 7G illustrates a diagram of a crossing S type routing pattern;

FIG. 7H illustrates a diagram of a emulation type routing pattern;

FIG. 8A illustrates a diagram of a routing path density contour for a portion of a routing surface;

FIG. 8B illustrates a diagram of a cross section of a homogenized routing path density contour through a section parallel to one ordinate of a routing surface;

FIG. 9A illustrates a first portion of the flow diagram for the routing zone analysis;

FIG. 9B illustrates a second portion of the flow diagram for routing zone analysis;

FIG. 9C illustrates a third portion of the flow diagram for routing zone analysis;

FIG. 10A illustrates a rectangular shaped printed circuit board to be routed;

FIG. 10B illustrates a rectangular shaped printed circuit board to be routed including the creation of zone quanta of the surface to be routed;

FIG. 11C illustrates a portion of the rectangular printed circuit board to be routed illustrated in FIGS. 10A and 11B showing the assignment of ordinal numbers to the zone quanta;

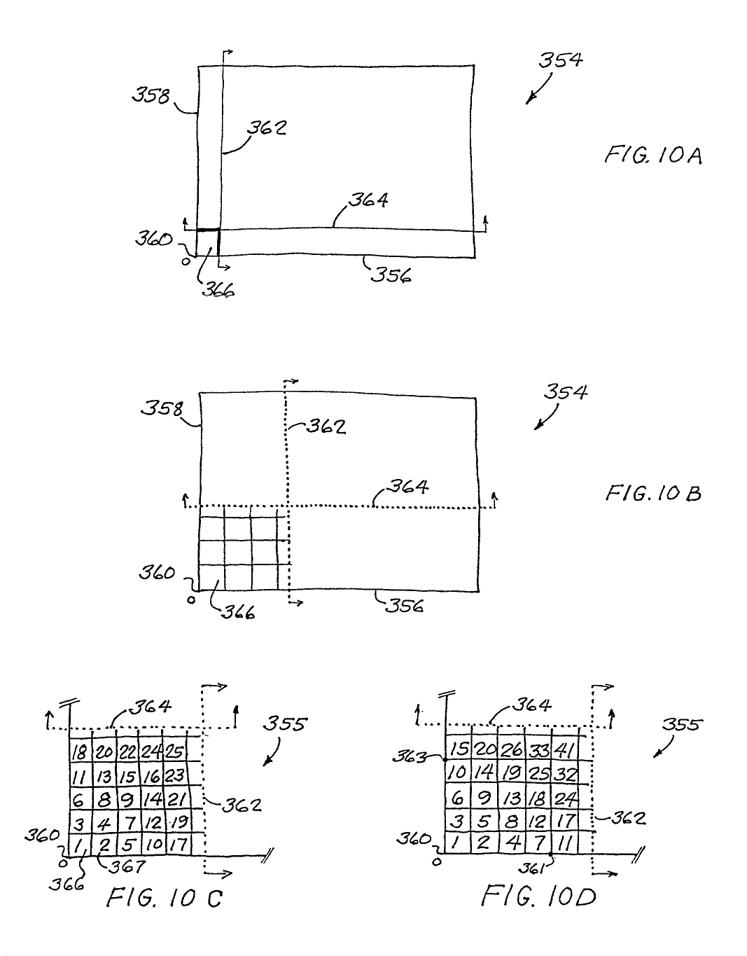

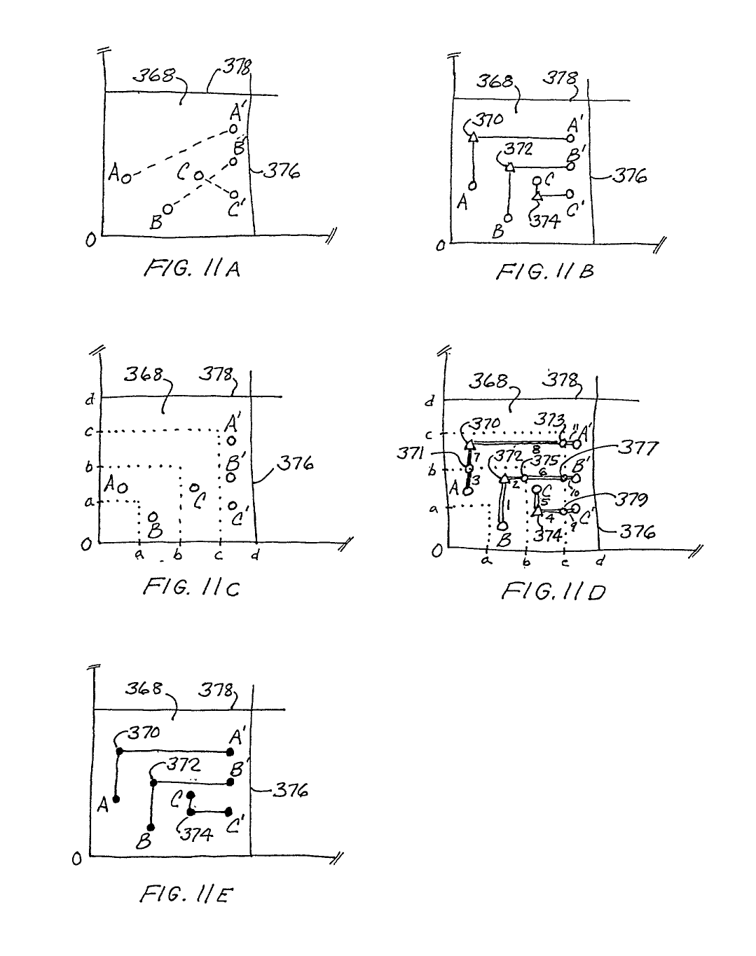

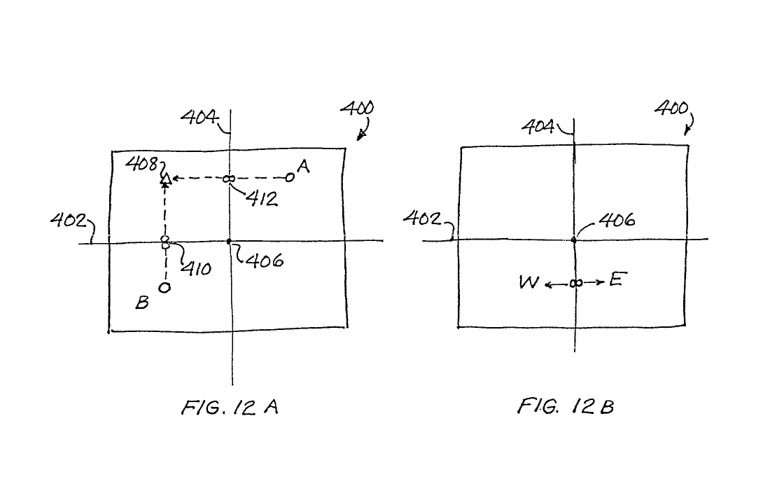

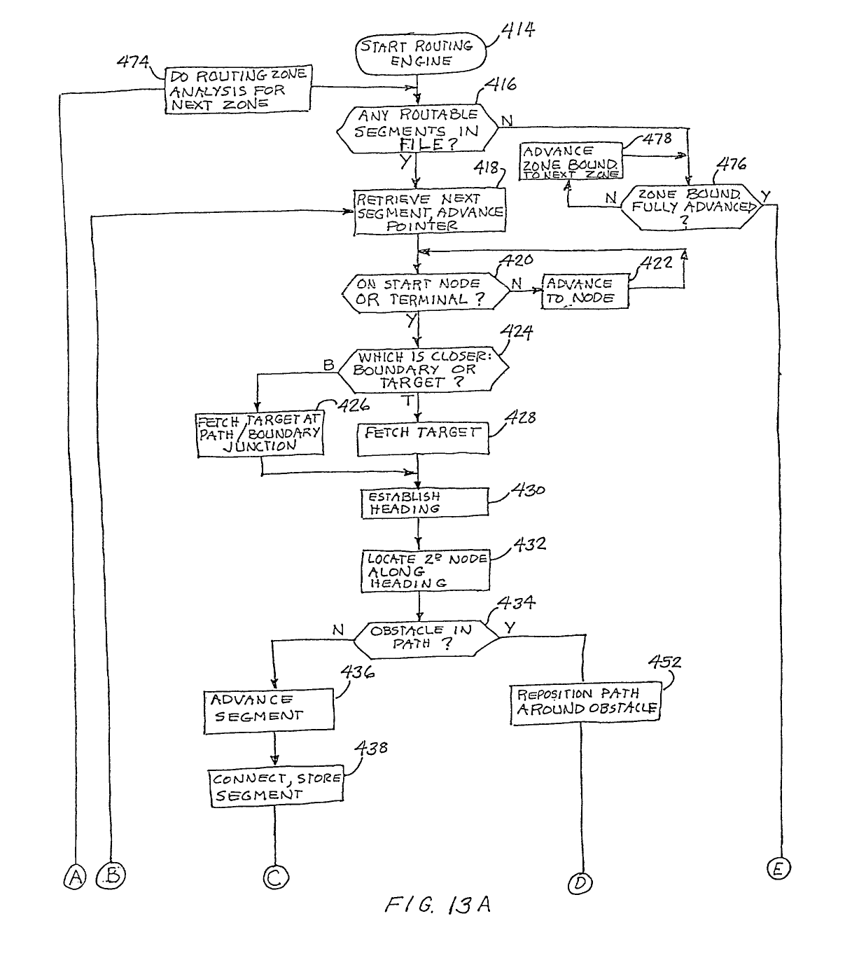

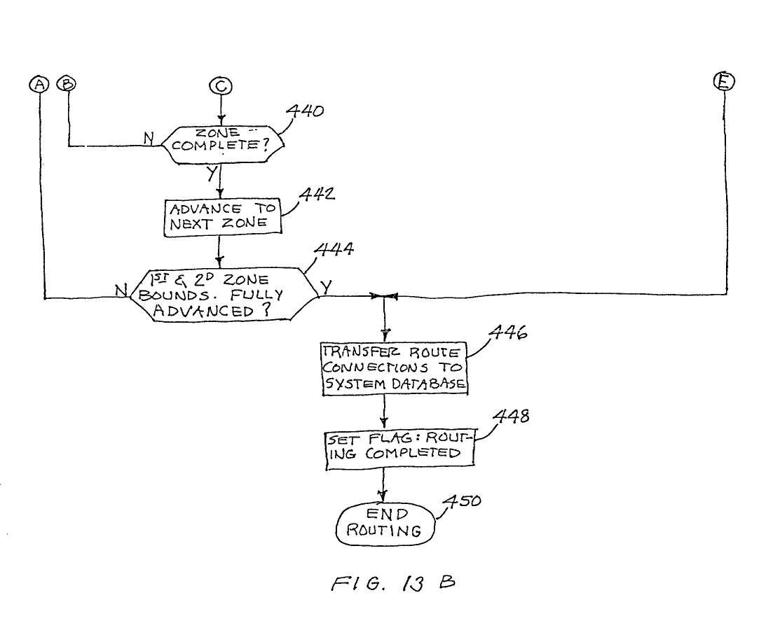

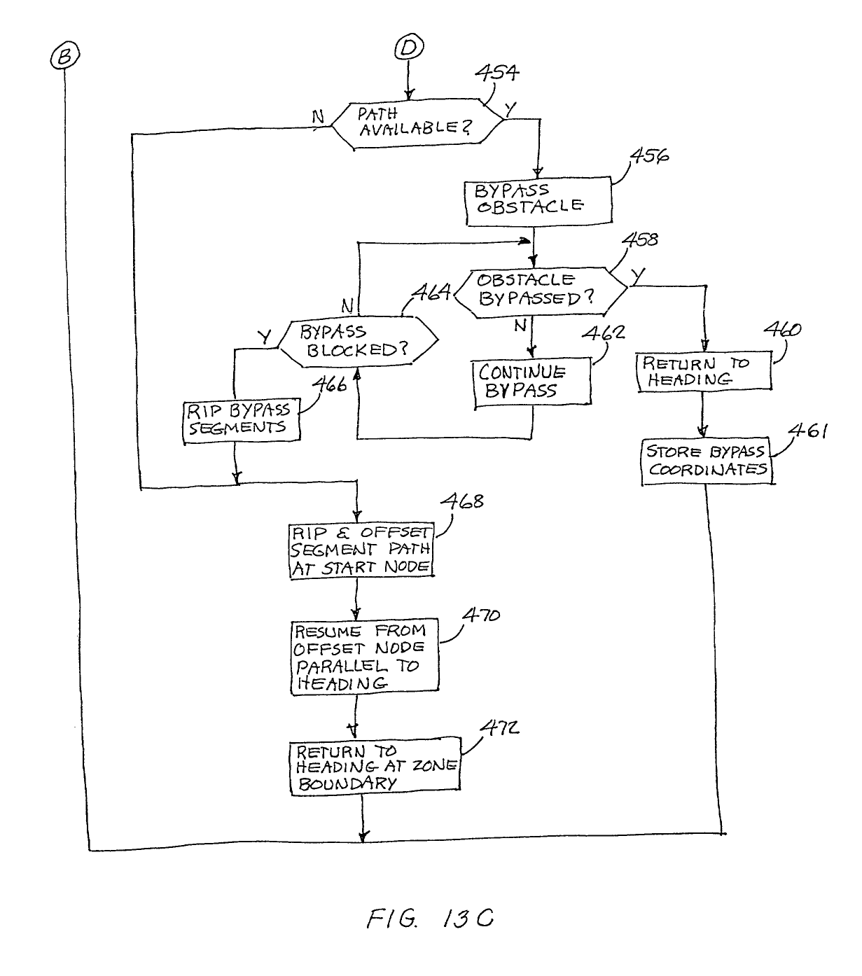

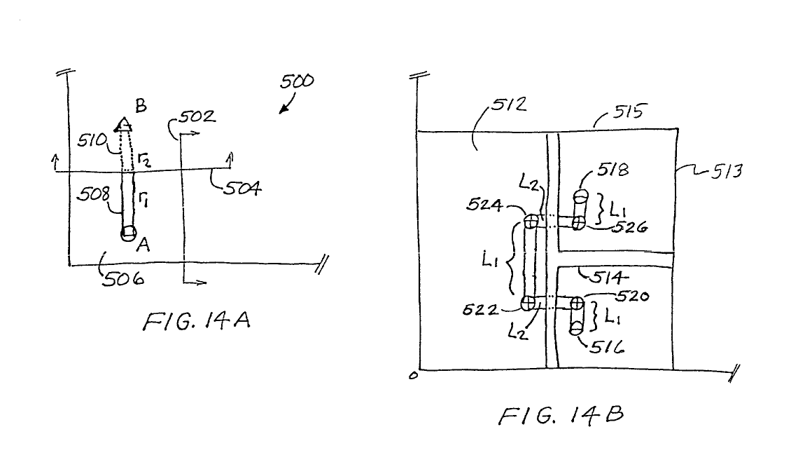

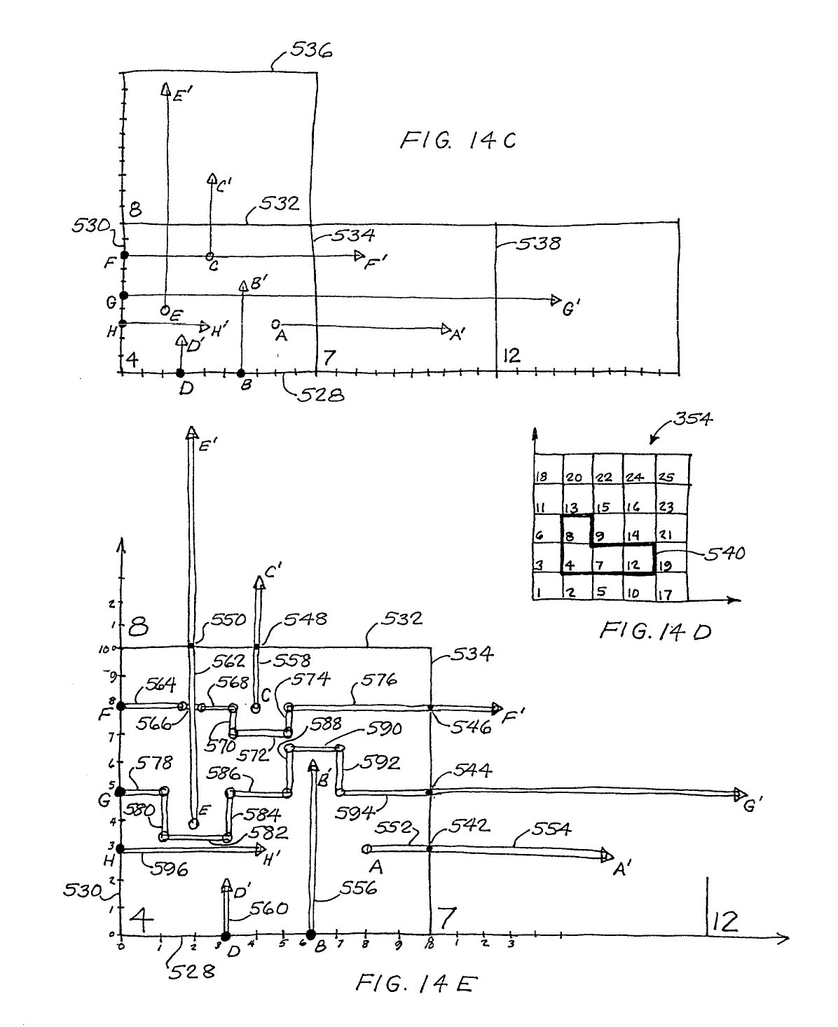

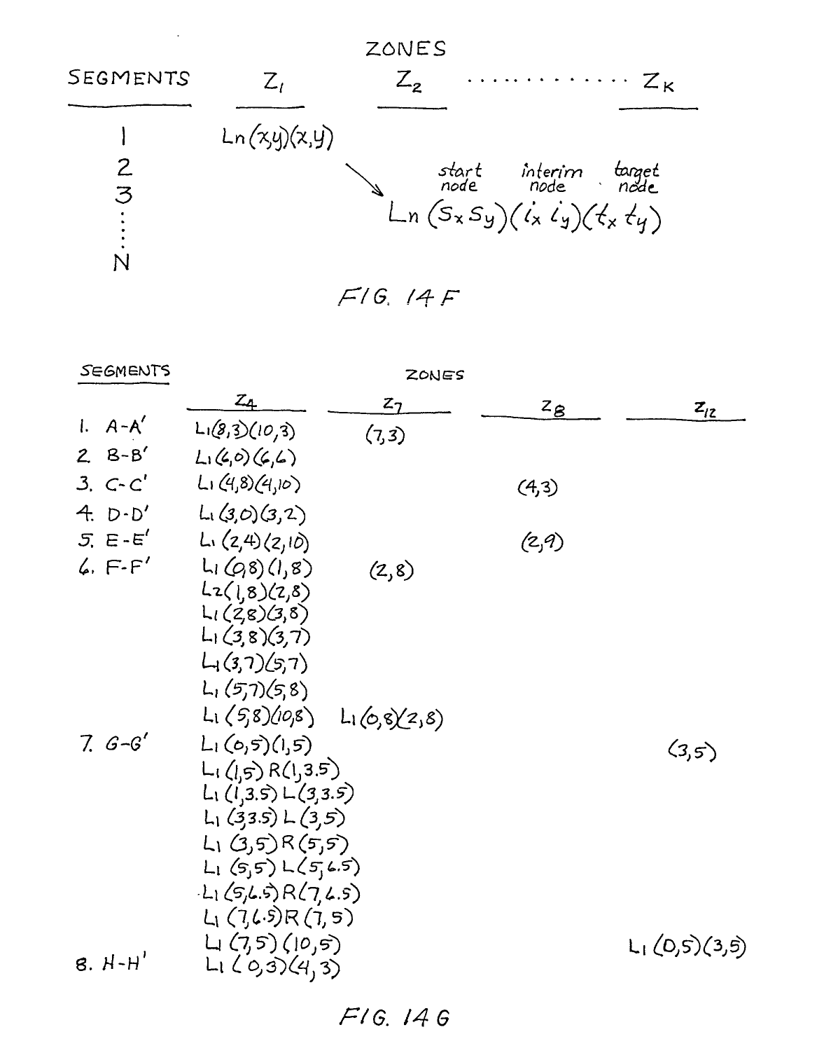

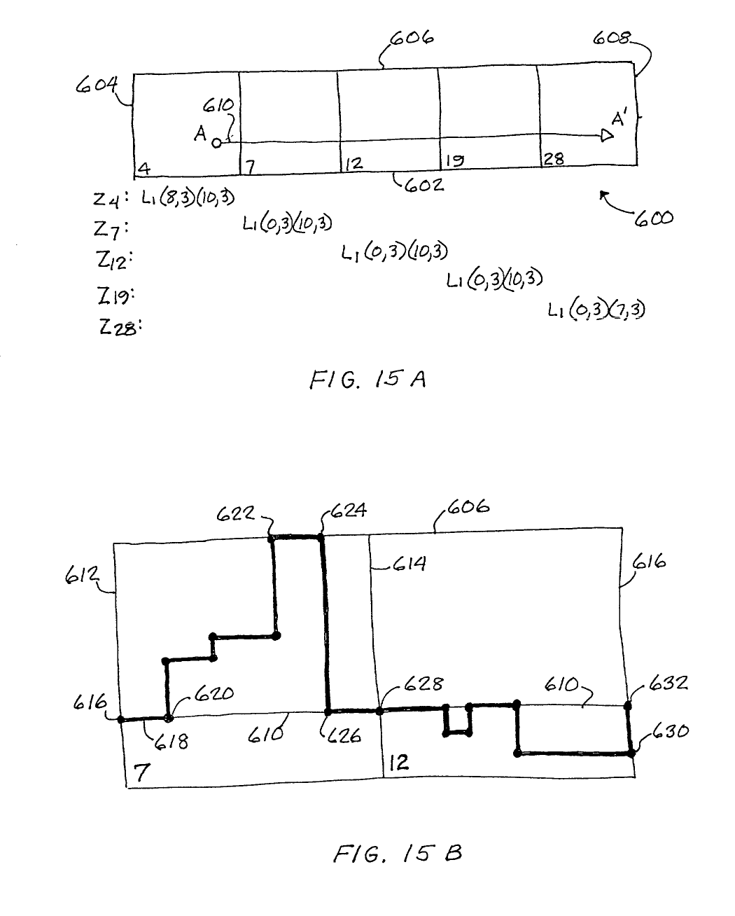

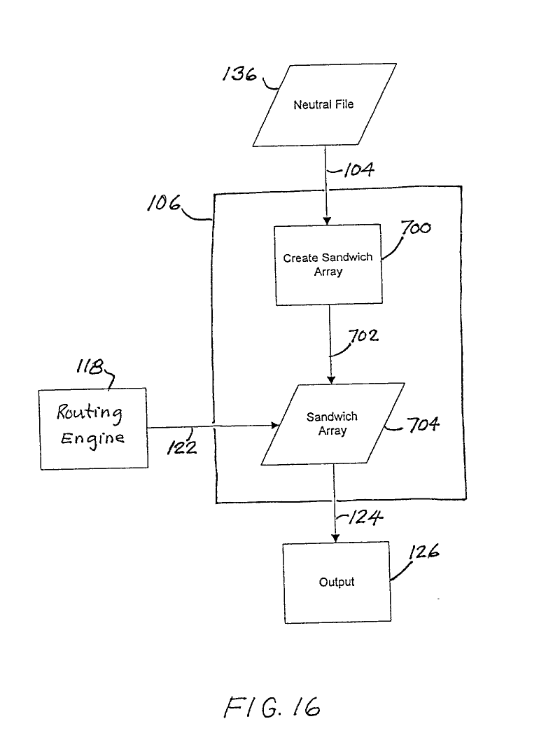

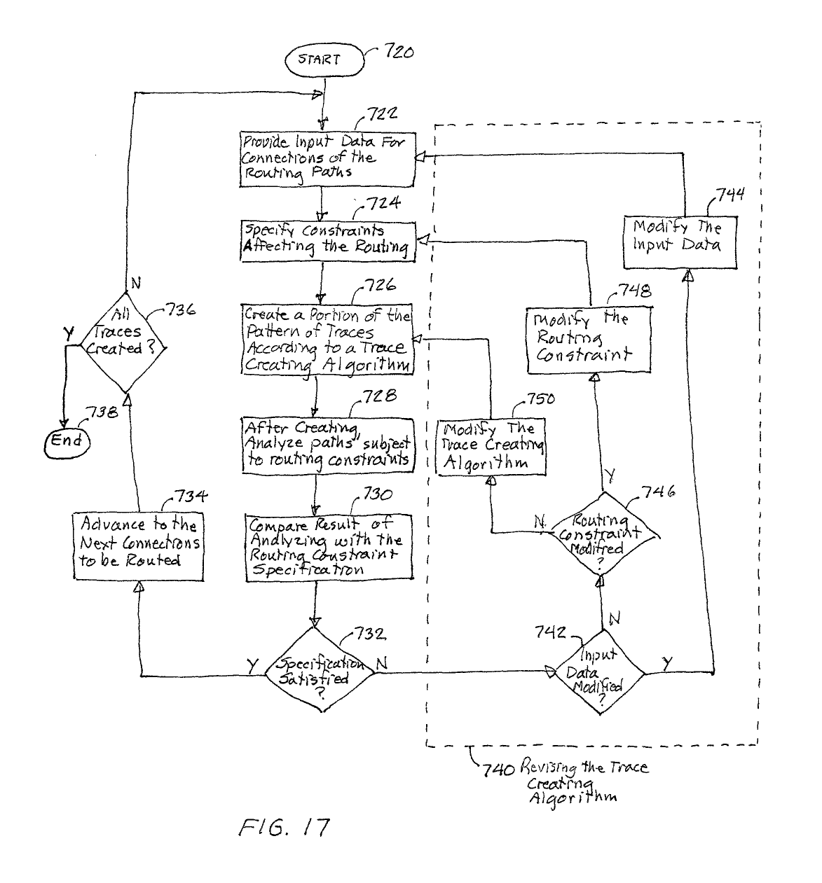

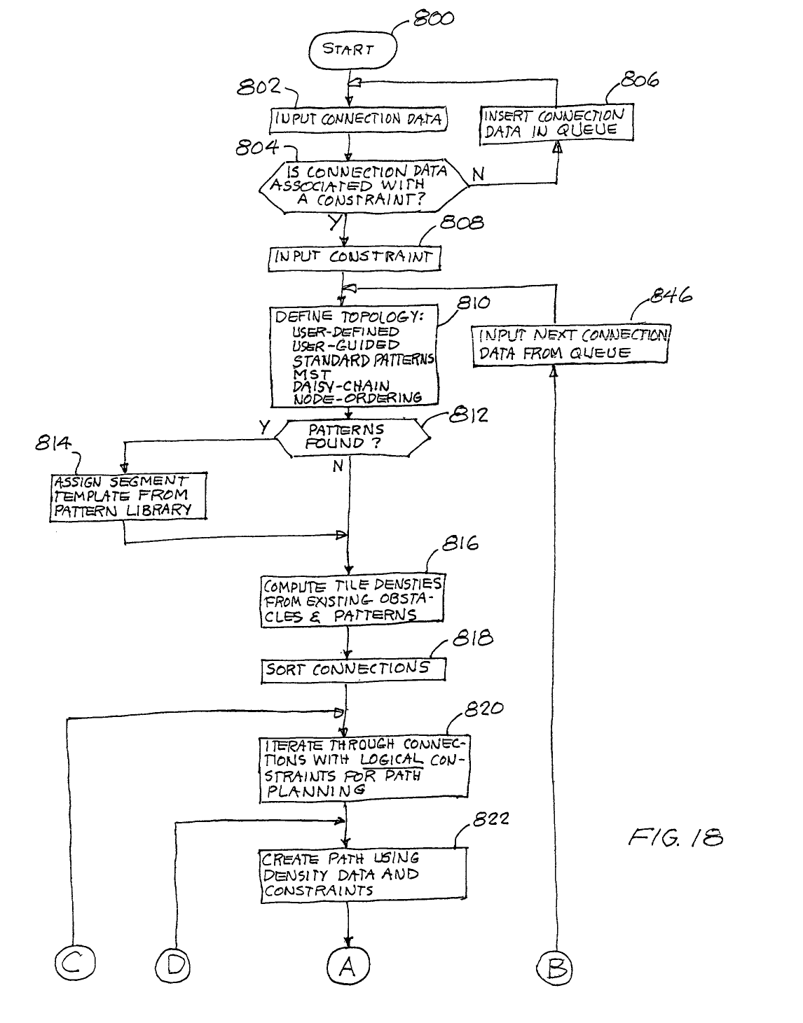

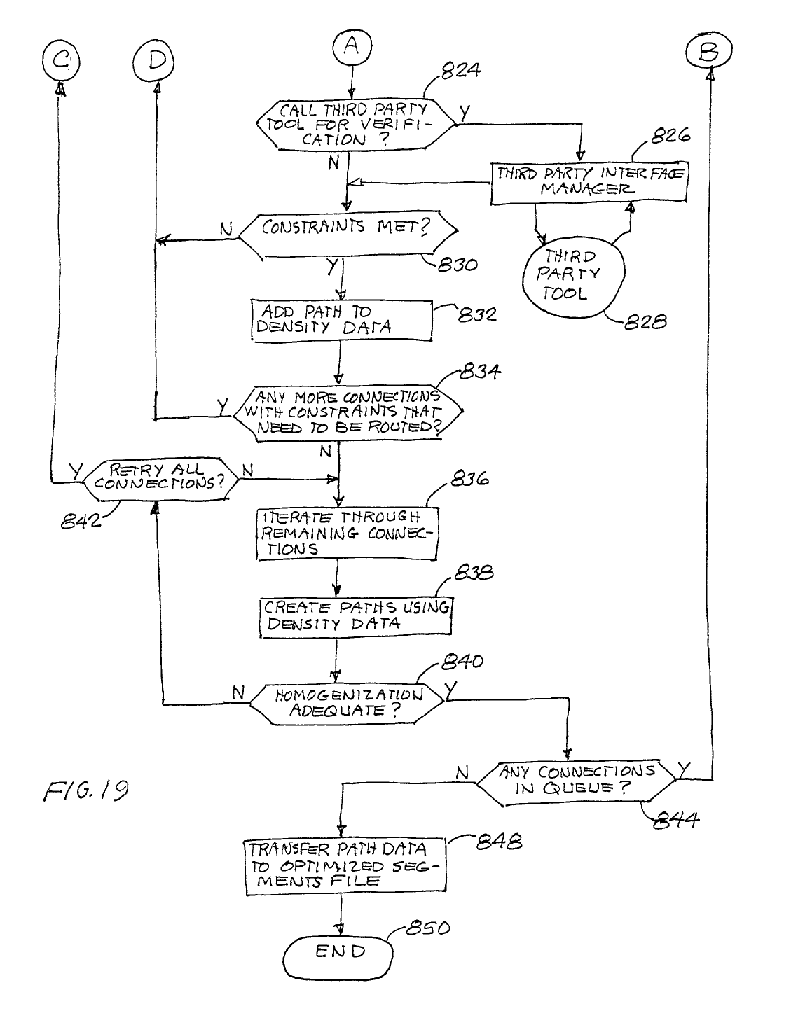

FIG. 10D illustrates a portion of the rectangular shaped printed circuit board illustrated in FIGS. 10A and 10B including an alternate method of assigning ordinal numbers to the zone quanta;

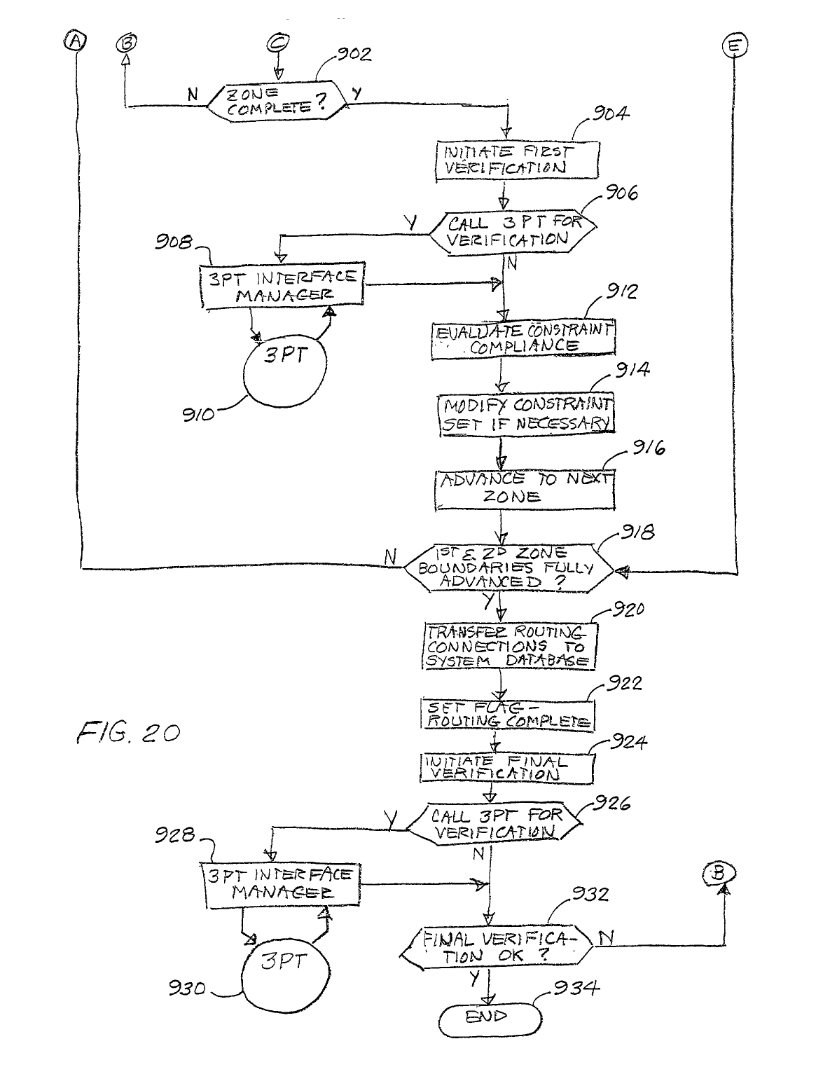

FIG. 11A illustrates a portion of a circuit surface to be routed for three segments;

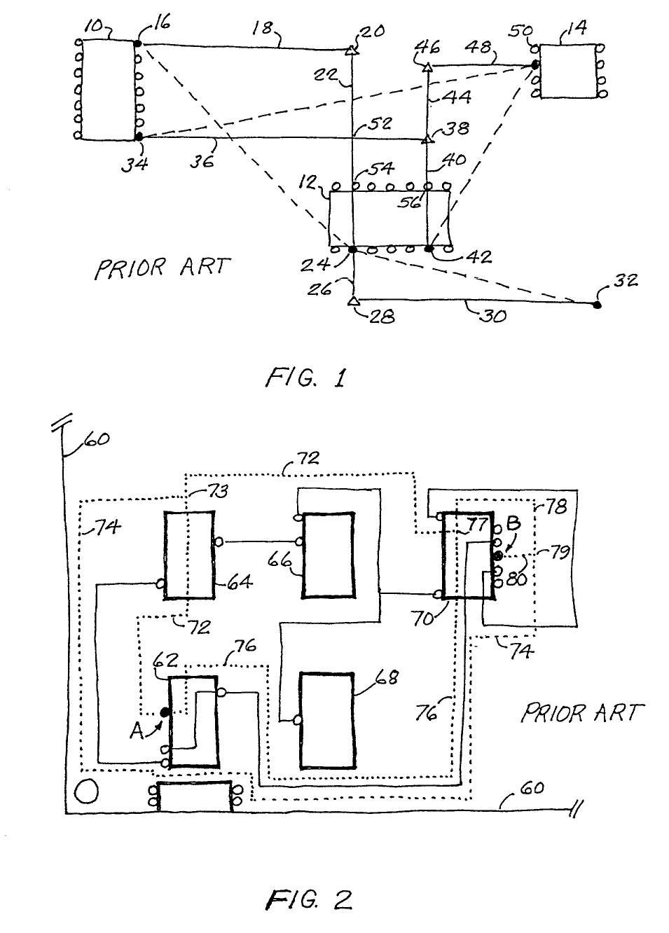

FIG. 1B illustrates the orthogonalization of the three segments illustrated in FIG. 11A;

FIG. 11C illustrates how successive portions of routing circuit are revealed as the unit routing zones are created;

FIG. 11D illustrates the development of routing path segments during routing zone analysis;

FIG. 11E illustrates the result of routing the routing path segments to produce routed segments or edges;

FIG. 12A illustrates an example of parallel processing by dividing the area to be processed among several processors;

FIG. 12B illustrates an alternative example of parallel processing by dividing the zones of the routing surface into as many parts as there are processors;

FIG. 13A illustrates a first portion of a flow diagram for the routing engine;

FIG. 13B illustrates a second portion of a flow diagram for the routing engine,

FIG. 13C illustrates the third portion of the flow diagram for the routing engine,

FIG. 14A illustrates the routing of a single path segment advancing within a zone quanta;

FIG. 14B illustrates a zone quanta in which a planned path segment is redirected around an obstacle;

FIG. 14C illustrates an enlarged portion of the routing surface exposed in FIG. 10C with path segments of zone quanta 4 to be routed;

FIG. 14D illustrates a portion of the board shown in FIG. 10C that includes the enlarged zones illustrated in FIG. 15C;

FIG. 14E illustrates an enlarged zone quanta 4 with the routing of path segments completed within zone quanta 4;

FIG. 14F illustrates an example of a table of routing segments useable for defining each segment for each zone;

FIG. 14G illustrates a portion of a table of routing segments for the segments of zone quanta 4 shown in FIG. 15E;

FIG. 15A illustrates a portion of the routing surface of FIG. 15C with a planned segment extended through a series of contiguous zone quanta;

FIG. 15B illustrates the contiguous zone quanta 7 and 12 as shown in FIG. 15C that includes a representative portion of the routed paths segment A-A′ in zone quanta 7 and 12; and

FIG. 16 illustrates a block diagram showing the structure of the system database;

FIG. 17 illustrates a simplified flow diagram of an alternate embodiment of a method for planning the routing of circuit paths;

FIG. 18 illustrates a first portion of a flow diagram of another embodiment of the operation of the analysis engine of the present disclosure;

FIG. 19 illustrates a second portion of the flow diagram of FIG. 18; and

FIG. 20 illustrates a flow diagram of an alternate embodiment of the operation of the routing engine of the present disclosure.

### DETAILED DESCRIPTION OF THE INVENTION

### The Routing System and Method

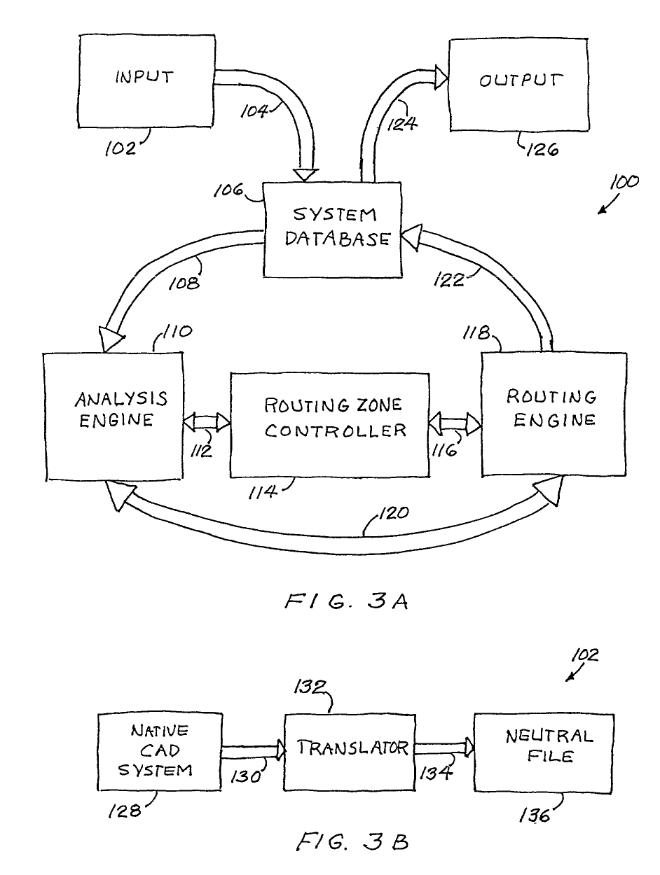

Referring now to FIG. 3A, there is illustrated a block diagram of a routing system 100 for routing complex paths of a circuit at high speed while minimizing the surface area required for routing the paths of the circuit. The block identified as input 102 represents the data entered by a user describing the circuit to be routed. This data, in the illustrative example described herein, includes a placement diagram, a net list, and certain constraints or rules to be followed in the routing process along with the geometry or mechanical parameters of the surfaces on which the circuit paths will be routed.

A placement diagram generally consists of a drawing that shows the location and physical outlines of all of the components that will be mounted on the routing layout surface. The components that could be included in a placement diagram include anything from wire terminals for connecting wires to the circuit, to passive components, to active components such as transistors and integrated circuits, to large scale integrated devices, and such other components as switches, connectors, sockets, plugs and the like. All of these components have terminals through which electrical signals enter or leave the component.

The net list is a list of all the terminals of all the components having connections to other terminals point connection of the terminals on each component with other terminals in the circuit to which they are to be connected. As pointed out in the glossary which follows hereinbelow, the net list represents the essence of the design by specifying all the connections in the circuit which are not embedded within a packaged component.

The third major item of input data representing a circuit to be routed falls in the category of the constraints for the routing that must be defined before routing begins. These constraints include information defining the geometry or mechanical parameters of the circuit medium or substrate, such as dimensions, the number of layers, the thickness of the substrate material between layers, and so on. Mechanical parameters for the completed circuit path which would include information on the width of the etch path or the copper trace in the circuit, the thickness of the copper, the kind of material used in the substrate, and so on. Other constraints include various restrictions, requirements and electrical routing characteristics such as the length of circuit paths, the width of certain circuit paths, which in some cases at high frequencies have a direct effect on the performance of the circuitry, and other parameters such as signal bandwidth, propagation time, group delay, cross talk, signal amplitude, characteristic impedance of transmission line circuits, source impedance, terminating impedance, standing wave ratio and passive distributed parameters such as capacitance and inductance. In general, any rule or specification or other parameter which defines the way the circuit should be routed and the environment in which the circuit is routed is included within the category of constraints.

Included in the process of entering the input data described above with reference to the input block 102 are such steps as formatting and encoding the data for data processing operations, which may be followed by a translating step to convert the encoded data into a form suited to a routing processor. Typically then, the input data processed by these steps is stored in a neutral file for access by a system database as will be described hereinbelow. During the entering and formatting steps, a coordinate geometry for the routing surfaces may be defined along with the placement diagram, net list and routing constraints. Defining the coordinate geometry may include enabling the routing of path segments in any direction on or among the routing surfaces and/or allowing mixed coordinate geometries to be used on the routing surfaces. It will be appreciated that a coordinate geometry defines at least an origin or a reference datum and may include one or more axes. Boundaries may also be defined on the routing surfaces by the coordinate geometry selected for a given routing project.

Continuing with FIG. 3A, there is shown a bus 104 proceeding from input 102 to the system database 106. The system database 106, which is the central storage facility of the routing system 100 is configured in the illustrative embodiment herein as a sandwich array structure which corresponds to the topographic parameters of the routing medium. Thus, the system database is created and organized for storing routing data defined and expressed in coordinate form within a specified area. Further, the system database may also be indexed for efficient and rapid read/write operation. Also shown in FIG. 3a is a bus 124 which provides the output path for the completed routing data provided to output block 126 to be described hereinbelow.

FIG. 3A illustrates three principal functional blocks in the routing system 100 of the present disclosure. The three blocks include an analysis engine 110, a routing zone controller 114 and a routing engine 118. These three functional blocks interact with the system database 106 and with each other as shown in FIG. 3A, which includes the bus structure connecting these major elements. Input data is provided to the analysis engine 110 along a bus 108 from system database 106. Similarly, output data from the routing engine 118 is provided along a bus 122 to the system database 106. The analysis engine 110 operates on the input data to develop a preliminary path routing plan and prepares it for processing by the routing zone controller 114. The routing zone controller 114 performs an extensive routing zone analysis to generate a plan for routing the circuit paths represented by the analyzed input data for routing by the routing engine 118. The analyzed input data supplied to the routing zone controller 114 is available along bus 112 which also handles two-way communication between the analysis engine 110 and the routing zone controller 114. Similarly, bus 116 is a two-way bus which provides for the exchange of data and commands between the routing zone controller 114 and the routing engine 118. It is also shown in FIG. 3A that the analysis engine and the routing engine 118 are coupled together by an independent bus 120 which also provides a two-way path for the exchange of data between these two functional elements.

The general function of the analysis engine 110 is to process the input data, including defining a coordinate geometry for the routing surfaces. The analysis engine 110 also determines the preliminary path routing plan by analyzing the data provided from the system database 106 along bus 108 to define the circuit paths to be routed. The analysis engine 110 performs a high level process which analyzes connection patterns and path densities and then homogenizes the path densities to create a tentative routing plan for the circuit. The analysis engine 110 also creates data files for the connections of the segments of the routing path and for saving routing data in various forms during the process of creating the preliminary routing plan, such as a collapsed segments file, an orthogonal segments file, a density tile array file, and a file for optimized segments.

The general task of the routing zone controller 114 is to make use of the data stored in the various files by the analysis engine to organize the routing surfaces by creating routing zones and a file of routable segments. The routing zone controller 114 organizes the surfaces of the circuit board or substrate into zones, i.e., zone quanta, and provides for an orderly progression of processing from one part of the surface to be routed to all of the other parts of the surface to be routed. As it creates the routing zones, the routing zone controller 114 processes the routing path data from the optimized segments file created by the analysis engine 110 and redefines the path segments in terms of coordinates or other indicia of location within each zone quanta. The end result of the operation of the routing zone controller 114 is to define the order of the nodes or end points of each of the path segments to be routed and to determine the order or sequence in which each of the routing path segments in each zone quanta will be routed by the routing engine 118. This information expressed in coordinate form is then supplied along bus 116 to the routing engine 118. In the description which follows, the terms unit zone, zone quanta and routing zone will be used interchangeably.

Continuing with FIG. 3A, the third major element of the routing system 100 of the present disclosure is the routing engine 118. The basic function of the routing engine 118 is to implement the routing plan provided by the routing zone controller 114. Because of the way the routing zone controller 114 processes the routing data essentially in a parallel fashion by advancing each routing path segment within each zone quanta in an incremental fashion, the routing engine 118 is enabled to perform the routing for all of the paths in each zone quanta in the same manner as soon as the routing zone analysis is completed for a particular zone quanta by the routing zone controller 114. The routing engine 118 essentially performs low level processing on a zone-by-zone basis as the routing zone analysis is completed by the routing zone controller 114. The routing of all of the path segments is performed in a progressive fashion within each zone by advancing each segment incrementally in turn, routing the segments around obstacles and storing the path routing data in the system database 106 as the routing engine 118 proceeds across the circuit routing surface or substrate zone quanta-by-zone quanta. The routing engine 118 operates in step with the routing zone controller 114 during the creation of the routing zone quanta and the routing plan that is generated during the routing zone analysis by the routing zone controller 114. Thus, the routing zone controller 114 and the routing engine 118 perform their processing functions together, across the circuit surface from the origin to the destination of the circuit surface as defined by the board geometry.

The routing system 100 shown in FIG. 3A in block diagram form can be implemented in currently available high performance desktop computers or a network of such computers which may be organized to operate in parallel for complex routing projects. The routing system of the present disclosure described herein thus comprises the above described computer system which operates according to software which will be described in functional terms herein.

Proceeding now with FIG. 3B, there is illustrated a functional block diagram representation of input block 102 shown in FIG. 3A. Input 102 comprises the user's native computer-aided-design (CAD) system denoted by native CAD system 128, which is coupled to a translator block 132 along bus 130. Similarly, translator 132 is coupled to a neutral file 136 along bus 134. The neutral file 136 is provided to retain input data that has been translated from the user's CAD system into a form accessible by the routing system of the present disclosure. The neutral file 136 contains input data in a common language that provides adaptation of the routing system 100 of the present disclosure to the native CAD system of any user employing the routing system. Since the functional blocks illustrated in FIG. 3B are well known in the industry, the operation of the each of these will not be described further herein.

In the detailed description which follows, a number of technical terms will be utilized which, though they may be understood by persons skilled in the art, nevertheless, may take on meanings which are unique to the system to be described hereinbelow. Therefore, the following glossary of terms is provided.

Collapse—Process of minimizing etch associated with a pair of edges,

including resolving an edge or segment into orthogonal components.

Connection—A pair of terminals to be connected in a net. Connections are generated by a minimum spanning tree or similar calculation performed as part of path data analysis.

Constraint—A general term for rules to be applied to any aspect of the routing process.

Destination—The end node of a path segment or the physical location of the end of the routing processing.

Edge—Line representing a trace connecting a pair of nodes. The edge defines the pair of nodes.

Geometry—The class of objects which define the shape and location of a feature on a single layer.

Grid—The unit space quanta defined by a discrete coordinate system.

Heading—The direction of the destination node of a path segment from its start node.

Jog—Router action in which an etch trace is laid for a short distance perpendicular to its heading or primary layer direction to avoid an obstacle and minimize vias.

Keepin—Board region a given signal must stay within.

Keepout—Board region a given signal may not enter.

Location—The x,y position on the board.

Manhattan—The total orthogonal distance, in the reference frame of the board, between two locations. Mathematically-the boxcar metric.

Net—List of connected terminals.

Net list—List of nets. Represents the essence of the design. Supplied by the designer.

Neutral File—A file format into which all design databases will be translated, and to which all routing data will be written. There may be many translators, but only one Neutral File.

Node—A terminal or a target. Connection of a trace at a terminal or another trace (target point). Expressed in terms of its coordinates.

Node Order—A list of nodes in order of connection. Used to define topologies.

Order of Nodes—Order in which the coordinates of the start node and the destination node of a path segment are expressed.

Orthogonalization—Process of ensuring that all segments are (nearly) parallel to a board axis.

Path—The specification of unplaced segments that will connect the terminals in a net.

Pin—The lead of a component that connects to a through-hole on the board.

Rule—General term for any constraint on how nets can be routed.

Segment—A pair of nodes to be connected in a net/connection. Segments consisting of two terminals are identical to their parent connections. If a target is inserted between two terminals in a connection, two segments are generated. A connection completed is an edge.

Start Node—the first node coordinate in the expression for a path segment.

Target—Any point of connection between segments which is NOT a terminal.

Terminal—Point at which electrical connection is made between the board and the component.

T-junction—Intersection of three traces not at a terminal. For example, target node is defined as a T-junction.

Trace—Rectangular etch on a single layer wherein the trace has dimensions of width and length.

Via—Interlayer connection. Usually implemented with through hole.

Virtual Node—Synonymous with target.

### The Analysis Engine

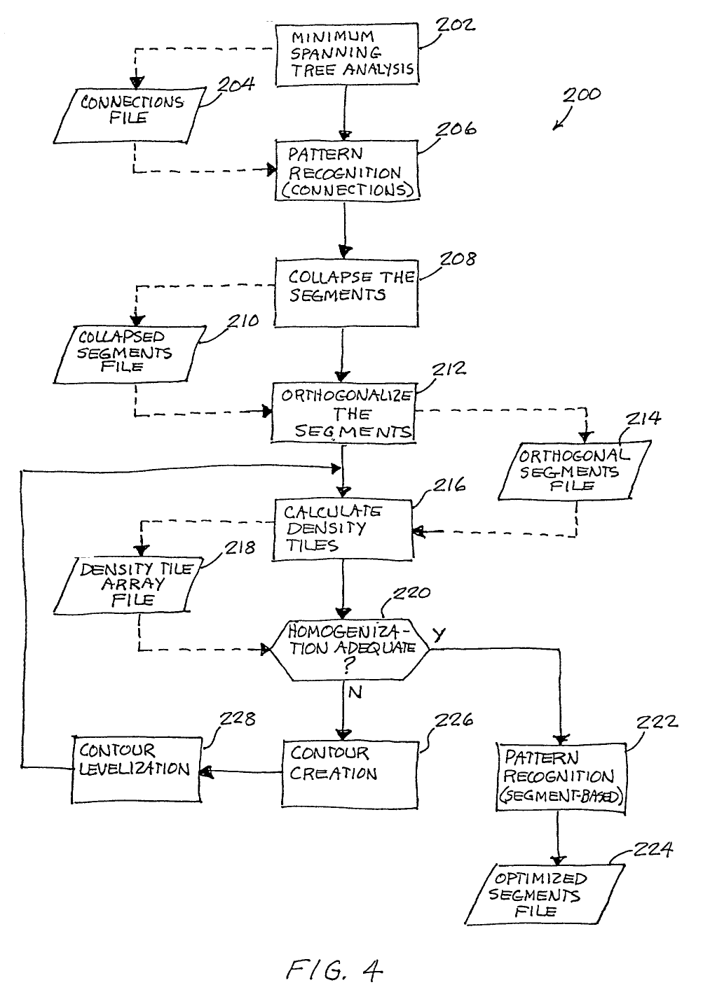

FIG. 4 illustrates a flow diagram for the analysis engine 110 shown in FIG. 3A. The analysis flow to begin defining the circuit paths begins at block 202 where the input data is subjected to a minimum spanning tree analysis. The minimum spanning tree analysis connects the nodes in the net list without regard to crowding or angles. For example, if five nodes connect to the same path according to the net list, then the minimum spanning tree analysis (MST) selects the shortest path connecting all five nodes. The result of this analysis is a connections file shown in block 204 in which all of the point-to-point connections in the net list are stored. Further, all of the connections stored in the connections file 204 are the minimum length path that could be used to connect the nodes involved. The connections file 204 is essentially the result of an operation on the net list with the connections made between the nodes in the shortest, most direct possible way. A simple illustration of the effect of minimum spanning tree analysis as performed in block 202 is illustrated in FIG. 5 discussed in detail hereinbelow.

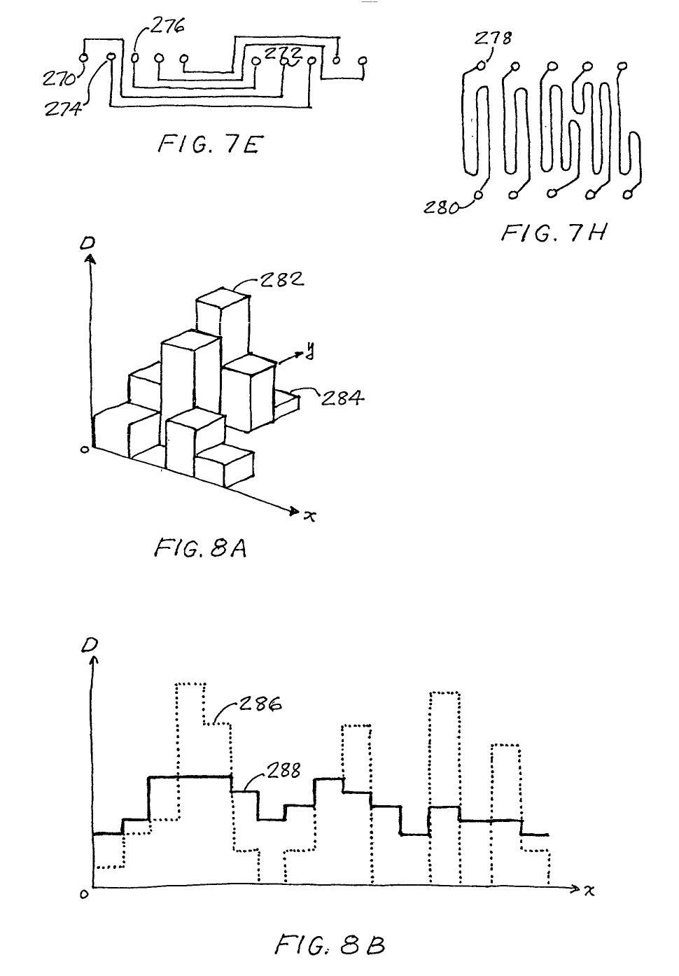

Continuing with FIG. 4, the flow proceeds from block 202 to block 206 wherein a pattern recognition analysis is performed of all of the connections stored in the connections file 204. In this pattern recognition step, the connections are analyzed for their resemblance to certain standard patterns which frequently occur in circuit layouts. When a connection pattern is identified as resembling one of the standard patterns shown in FIG. 7, to be described in detail hereinbelow, the actual connection stored in the connections file 204 is substituted by a description containing the so-called standard pattern for that particular arrangement of connections. This step is performed in order to pre-route the actual terminal connections in the net list in a way that reduces the amount of routing that must be performed upon the connections file data. The standard patterns may, for example, be repetitious patterns from a library of such patterns accumulated from routing experience. It may be the case in some circuit routing problems that the pattern recognition steps comprise most of the analysis that is required-or certainly this may be true for the routing plan development of portions of a routing project-thus the pattern recognition may, in fact, be implemented in some applications as an independent process. Similarly, the pattern recognition step may be skipped in certain applications. Following the pattern recognition step of the connections in block 206, the flow proceeds to block 208 to perform the step called “collapse the segments.”

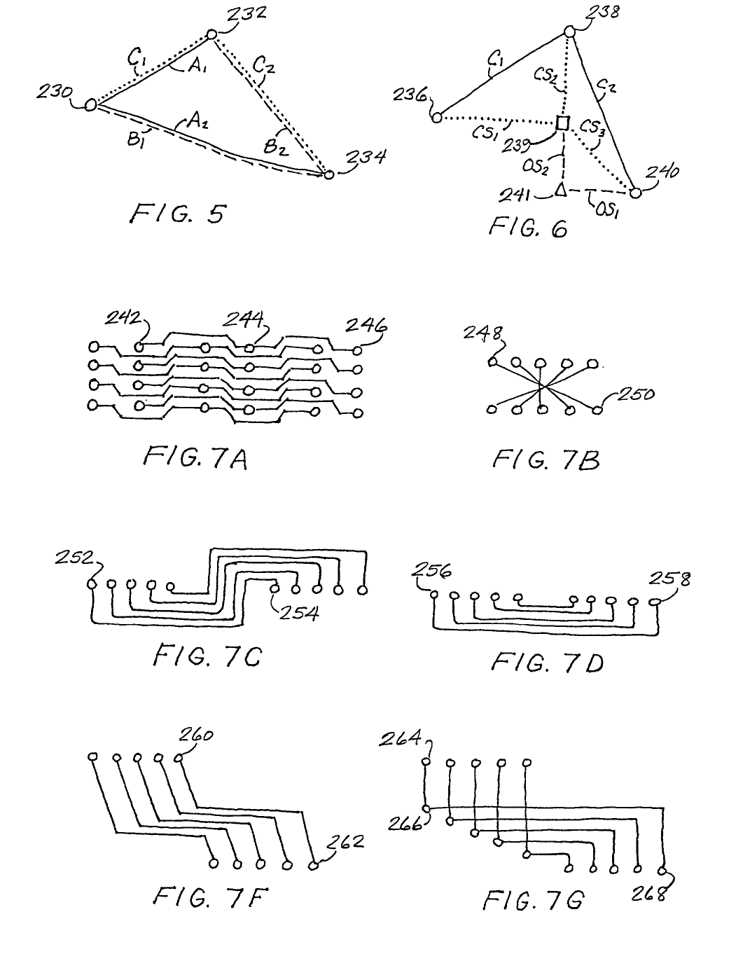

Continuing with FIG. 4, the next steps to be described comprise operations to resolve each of the direct path connections between each pair of nodes from a straight line, regardless of its direction, to its orthogonal components. It is well known that in a typical circuit layout the circuit paths or traces run in a horizontal or vertical direction with reference to the coordinate system used to locate elements of the circuit. Thus, every path between a pair of nodes or terminals which is generally a diagonal path, must be reduced to its orthogonal components; that is, to the component that runs in the horizontal direction and the component that runs in a vertical direction, in order to maintain spatial efficiency for the specified path between the two nodes. Thus, in a path which connects several nodes together, the first step in block 208 is to collapse the segments, meaning to replace the direct path between a pair of nodes with the equivalent component paths, may typically, but not always, be orthogonal, between those two nodes. This step will be illustrated in further detail in FIG. 6 hereinbelow. The results of the operations to collapse the segments in block 208 is stored in a collapsed segments file in block 210. Following the collapse the segments operation in block 208, the flow proceeds to block 212 in which the step “orthogonalize the segments” may be performed on the data stored in the collapsed segments file 210. This step operates on a new direct path created that runs from the node that joins the two orthogonal components of the previous collapsed segment to the next node in the path, which would then in turn be orthogonalized and stored in a separate file called the orthogonal segments file in block 214. The orthogonalization of the segments in step 212 will be explained further in detail with respect to FIG. 6 hereinbelow.

Continuing with FIG. 4, the flow proceeds from the block 212 to a block entitled “calculate density tiles” in block 216. The blocks in FIG. 4 identifying the next several steps illustrate one of the key processes in the routing system 100 of the present disclosure. After all of the connections resulting from the minimum spanning tree analysis have been resolved and collapsed into their orthogonal equivalents, the routing system 100 of the present disclosure performs an analysis to evaluate the density of circuit routing data throughout the surface area to be routed and to relocate some of the paths, terminals, vias and other routing data objects concentrated in high density areas to other regions of the surface area where the routing data density is much lower. This process will allow a relatively uniform density of circuit routing data to be achieved throughout all areas of the circuit, thus providing the maximum utilization of the available routing space while keeping the total surface area to be routed at a minimum. This process of achieving uniform density of circuit routing data is called homogenization.

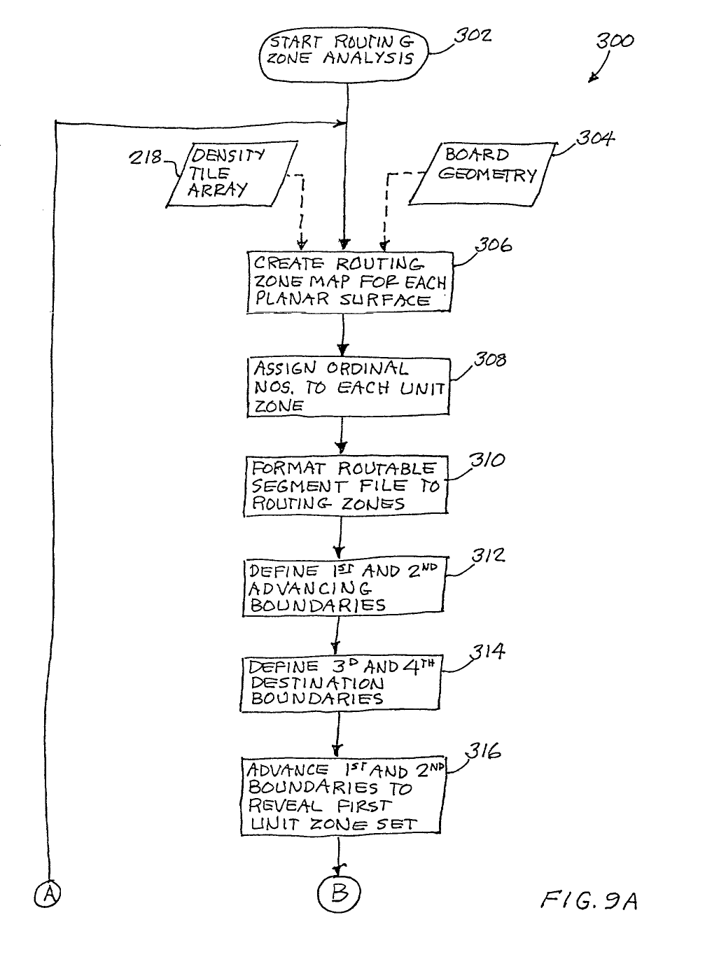

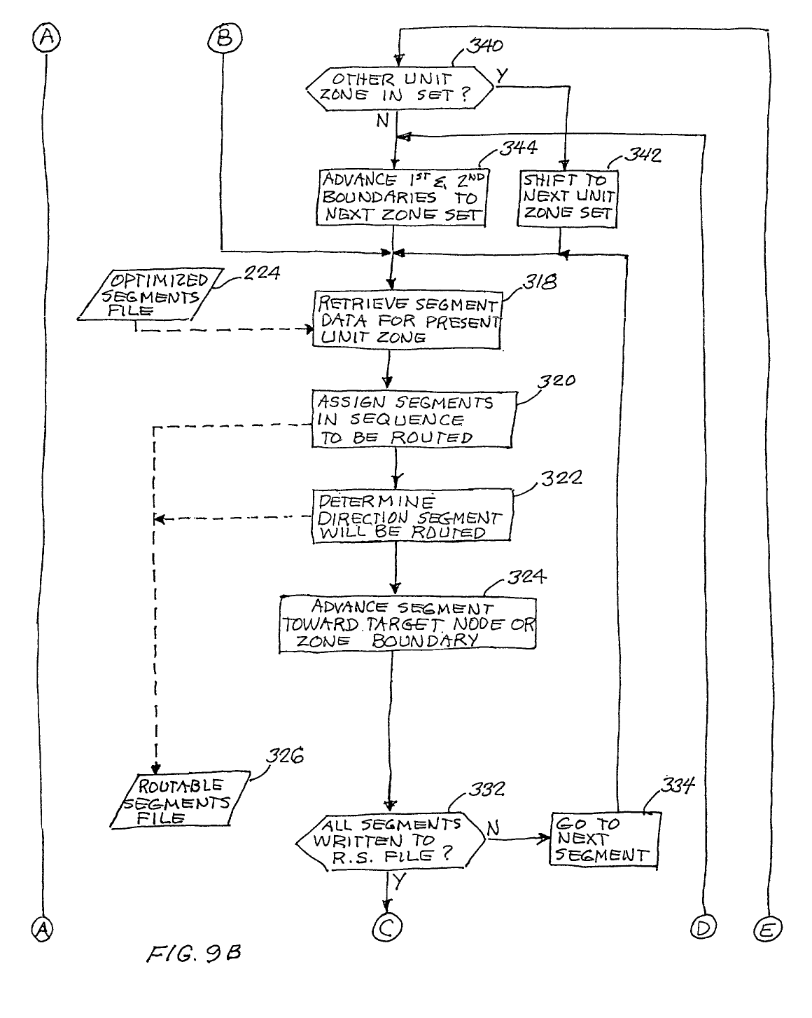

As shown in FIG. 4, the step “calculate density tiles” in block 216 follows the step “orthogonalize the segments” in block 212 and analyzes the data from the orthogonal segments file 214 by calculating the density of the routing data that pass through given unit areas of the surface to be routed. The results of these calculations of the density of the circuit routing data are stored in block 218 which is called the density tile array file. The flow then proceeds to block 220 for testing of the data to determine if the homogenization of the circuit routing data is adequate in block 220. In block 220, for example, the value for the path density of the most dense unit area is compared with a predetermined index figure D. The index figure D may be determined by such factors as the run time for the routing process, acceptable limits for the density of circuit routing data in a given unit area, and so forth. If the comparison result previously described is less than or equal to the index figure D, the homogenization of that pair of unit areas is considered adequate. However, if the comparison results in a value which exceeds the index figure D, the homogenization is evaluated to be inadequate. In the latter case, the analysis may further proceed along the “N” path to block 226 to perform the step “contour creation.” This step performs a contour analysis by quantifying and plotting the density of routing data according to its unit area location. In effect, block 226 creates a contour map of the surface area to be routed that resembles a histogram as illustrated in FIG. 8a, which will be described in further detail hereinbelow. The data created in the contour creation step in block 226 is then evaluated in block 228, a contour levelization step, in order to re-plan or re-route some of the circuit objects from high density unit areas into unit areas having lower density, thus homogenizing the routing data densities.

The process of homogenizing routing data densities is illustrated in an example shown in FIG. 8b which will be described hereinbelow. Thus, the “contour levelization” step of block 228 effectively reroutes orthogonal segment paths from high density regions to less dense regions while remaining within the constraints defined at the outset with the input data. In order to relocate the paths or other objects that are being moved, the analysis engine performs maze routing techniques. It is noted that the process of rerouting segment paths or other routing data objects from high density areas to low density areas, since it disturbs the order of the paths in the segment files, includes the reordering of the sequence of adding paths to the data file.

Following contour levelization in block 228 of FIG. 4, the flow proceeds along the return path to the input of block 216 to again perform the step “calculate density tiles.” The homogenization process of blocks 216, 218, 220, 226 and 228 is repeated as long as the result of the test in block 220 to determine whether the homogenization is adequate continues to identify disparities in circuit routing data which exceed the index value D. During the analysis of the circuit routing data, a number of algorithms may be employed to calculate the densities, to evaluate the results and to levelize the disparate densities. The method described in the present disclosure is intended to be merely illustrative in order to illustrate the concept and not limited to the particular example used. Further, the homogenization step or the density analysis is one among several tools available to plan the routing for all of the circuit paths to be routed by the routing system of the present disclosure. Thus, for example, FIG. 4 has illustrated several major tools used in planning the routing for the circuit, such as the minimum spanning tree analysis, the pattern recognition, the orthogonalization of path segments, and the homogenization of circuit routing data densities.

One step which may be performed by the analysis engine in this illustrative example remains to be described, which is another application of a path planning tool used earlier, the pattern recognition of step 222. However, in this use of the pattern recognition step in block 222, instead of examining the connections data in the connections file, the analysis engine examines the routing plan data at the segment based level in order to optimize the routing plan. Here, in block 222, the analysis engine searches for repetitious segment routing patterns which resemble standard routing patterns as much as possible, i.e., as shown in the example illustrated in FIGS. 7A-7H. After identifying the routing segments to be optimized, and performing a pattern recognition analysis thereof, target locations from the standard routing pattern may be adapted to the new routing surface and a revised routing plan determined. In this way, each set of routing segments retrieved is from memory and similarly optimized. It will be appreciated further that the pattern recognition step performed in block 222 is another pre-routing step as in the earlier pattern recognition step. However, since the routing path segments include additional nodes assigned as virtual nodes or targets during the orthogonalization process, the segments that would be analyzed in a pattern recognition step will, in general, be different. Thus, to complete the analysis engine's routing plan, a pattern recognition step may need to be performed following homogenization in order to pre-route the circuit paths on the segment level. In some applications such pattern recognition analysis, as noted previously, may be performed as an independent step.

To summarize the operations performed by the analysis engine 110, the input data is defined in terms of point-to-point connections of the nodes in the circuit. Each connection is defined therein as a terminal-to-terminal connection, the terminals being those defined in the net list. In the process of orthogonalizing these connections between terminals, the analysis engine 110 defines intermediate or target nodes which are virtual nodes assigned by the analysis engine 110 in order to specify the location of a connection between the orthogonal components of the direct paths. For example, such a virtual node or target could be used to specify the junction of orthogonal paths which meet at a right angle. A virtual node or target may be temporary and it may be movable during routing analysis; other virtual nodes may be discarded after use. The analysis engine 110 adds circuit path data defined in the form of terminal-to-target and target-to-terminal and also between two targets. These additional and sometimes variable target nodes enable the analysis engine 110 to define all of the connections in the circuit between nodes which nodes represent the end points of circuit path segments which may be organized in orthogonal directions relative to the geometry of the circuit board surface. Following orthogonalization, homogenization and the subsequent pattern recognition step, the output of the analysis engine 110 operations is stored in block 224 which is called the optimized segments file.

Referring now to FIG. 5, there is illustrated an example of the minimum spanning tree (MST) analysis of a simple point-to-point connection of three nodes together. These three terminal nodes, defined among the connections specified in the net list, would typically be included among all of the input data retrieved from the system database 106 by the analysis engine 110. The three nodes to be connected together in this particular example are specified as node a 230, a node 232 and a node 234. The MST analysis is used to find the shortest sum of the possible paths that connect these three nodes 230-234 together. There are three possible paths that can be employed to connect these three nodes 230-234. A first possible path is shown in the solid lines represented by segments A1 and A2 connecting node 232 to node 230 and node 230 to node 234. A second possible path is represented by segments B1 and B2, represented by dashed lines connecting node 230 to node 234 and node 234 to node 232. Yet a third possible connection of the three nodes is shown by the dotted lines, represented as segments C1 and C2, connecting node 230 to node 232 and node 232 to node 234. The MST calculates the length of each segment and adds the corresponding segments together to evaluate which of the three combinations of segments has the shortest overall length. In this simple example shown in FIG. 5, it is easy to see by inspection that as long as the triangle represented by the three nodes 230, 232 and 234 does not have equal sides, the path represented by the sum of the lengths of segments C1 and C2 provides the shortest overall length of a path that connects nodes 230, 232 and 234 together. Therefore, the result of this MST analysis is to store the path segment information for segments C1 and C2 in association with the connection of these three particular nodes together.

Referring now to FIG. 6, there is illustrated a set of nodes to be connected taken from the net list which are connected together by segments C1 and C2, which segments were identified through the MST analysis of the previous step. Thus, in FIG. 6, node 236 is connected to node 238 along segment C1 shown by a solid line and node 238 is connected to node 240 by segment C2 also represented by a solid line. The task of the analysis engine is to resolve these two path segments C1 and C2 into orthogonal components. In a first step, the segment C1 is collapsed into orthogonal segments CS1 and CS2 which are joined together at right angles at a virtual node or target node at the location indicated by the small square and identified by reference number 239. Thus, target node 239 is the location of the junction of the two orthogonal segment components representing the single path C1. The next step is to orthogonalize the remaining path from target node 239 to node 240 shown in FIG. 6. This segment is represented by segment CS3 shown as a dotted line connecting target node 239 with terminal node 240. Segment CS3 is resolved into its orthogonal components shown in dashed line form as OS1 and OS2 which join together at target node 241 represented in FIG. 6 by a small triangle. Thus, the routing path segments connecting nodes 236, 238 and 240 together consist of the following: segment CS1 connecting node 236 with target node 239, segment CS2 connecting node 238 with target node 239, segment OS2 connecting target node 239 with target node 241, and segment OS1 connecting target node 241 with terminal node 240. It is seen that the segment paths that connect these three nodes together are now represented by segments which are directed in either horizontal or vertical directions relative to the coordinate system of the surface to be routed. Another way to visualize the connection arrived at in this process is to realize that node 238 is connected to node 241 by a segment comprised of both CS2 and OS2 together, and node 236 is connected to this segment at the target node 239. Similarly, node 240 is connected to target node 241 by segment OS1. It will also be appreciated that segment CS₂ represents part of an orthogonal component of both segments C₁ and C₂; thus these partial components or segments are said to be overlapping between node 238 and node 239. During the resolution of these overlapping segments, they will be combined into the minimum path length to satisfy the net list.

By way of review, FIG. 6 illustrates one of three analysis steps performed by the analysis engine. In step one, a minimum spanning tree analysis is performed on the connection information from the net list to find the shortest total length of the path segments required to connect the three nodes together. Then in step two, the first segment of this combination of path segments is then collapsed or resolved into its orthogonal components at a virtual or target node specified as a point on the surface where these orthogonal components meet at a right angle. In a third step, the path segment that connects this virtual target node to the remaining node to be connected is then similarly resolved into its orthogonal component at a second virtual node defined as the location where the two orthogonal segments representing this last connection meet at a right angle. The analysis engine then repeats this same process to resolve into component segments all of the paths represented in the net list.

In the previous description with respect to FIGS. 5 and 6, one of the steps performed by the analysis engine 110 was omitted in order to clarify the operations performed by the analysis engine 110. At this point, it is appropriate to return to FIG. 4 and describe the pattern recognition step that is performed upon the connections which are stored in the connections file 204 in step 206. In this step, in block 206, a pattern recognition analysis is performed on the connections themselves prior to any collapsing or orthogonalization of segments occurs in order to simplify or in effect, pre-route, the connections contained in the net list after the minimum spanning tree analysis. The pattern recognition step in block 206 proceeds by replacing routing path combinations which resemble standard paths, thus eliminating the need to separately plan the routing for combinations of path segments which are highly repetitive or unduly complex. Some standard routing paths utilized in this illustrative example are described hereinbelow with reference to FIGS. 7A-7H.

Referring now to FIGS. 7A-7H, there are illustrated some examples of standard path routing patterns used to substitute for circuit patterns or routing patterns which tend to appear repetitiously in the particular circuit routing being processed by the routing system of the present disclosure. In FIG. 7A, there is illustrated a memory type routing pattern. FIG. 7A shows groups of terminals representing three eight-pin integrated circuit packages arranged in parallel fashion. The memory type pattern is frequently used when a number of circuit components that are identical are connected together. In the example shown in FIG. 7A, the upper, right hand pin of each component is connected together by a single path. For example, terminal 242 is connected to terminal 244 is connected to terminal 246 by a single path. Similarly, each of the other terminals on the left hand component package is connected to the corresponding terminal of each of the other two component packages.

A second common pattern is shown in FIG. 7B which represents, for example, a single multi-terminal component in which diagonally opposite terminals are connected together. The group of connections will cross essentially in the center portion of the component outline in such a way that all of the paths (in this case there are five segments) will meet in the center. However, it is desirable that none of these paths actually intersect to maintain the signals flowing in each of the paths separate from each other. A standard routing pattern will be substituted for this particular connection pattern every time it occurs on the routing surface.

FIG. 7C illustrates another common pattern known as a parallel pattern in which corresponding terminals of a component are connected together by essentially parallel paths. For example, in the left hand group of five terminals, node or terminal 252 is the first terminal on the left and similarly, in the right hand group of five terminals, terminal 254 is the first terminal on the left. In the particular example shown in FIG. 7C, terminal 252 is connected to terminal 254 and the second terminal of each of the 5-pin components is connected to the second terminal of the other component, and so on for the third, fourth and fifth terminals.

FIG. 7D shows an arrangement of terminals similar to the two 5-pin components as in FIG. 7C. However, the first terminal on the left, terminal 256 of the left hand component, is connected to the farthest terminal on the right of the right hand component, terminal 258. Similarly, the next terminal in the row from opposite directions are connected together and so on until all five pairs of terminals are connected together by essentially parallel routing paths. The illustration in FIG. 7D is distinguished from the standard pattern of FIG. 7C by calling it a parallel crossing pattern.

Continuing now with FIG. 7E, there is shown an example of a mixed parallel routing pattern. Again, two groups of five terminals are arranged in a single row of terminals. In this case, the left hand terminal of the left hand group of five terminals is not connected to one of the end terminals of the other group of five terminals, rather to one of the intermediate terminals of the five terminal component. For example, terminal 270 is connected to terminal 272, terminal 274 is connected to the middle terminal of the right hand set of five terminals. Terminal 276 which is the middle terminal of the left hand group of five terminals shown in FIG. 7E, is connected to the far, right hand terminal of the right hand group of five terminals in FIG. 7E.

Referring now to FIG. 7F, there is shown an “S” routing pattern. Here, the two sets of five in line terminals representing terminals on a single component or on separate components, are connected together through parallel lines. However, because of the way the groups of terminals are offset and the need to maintain essentially orthogonal paths between terminals, the pattern shown in FIG. 7F enables an orthogonal representation of the paths to connect corresponding terminals of each of these five sets of terminals together.

It will be appreciated that in some of the examples given above, for example FIGS. 7A, 7C, 7D and 7F, that the most efficient way to route these terminals together is to organize these paths in parallel with each other. This is an example of a design rule or a constraint that is applied to the routing of circuit paths on a circuit to be routed. Continuing now with FIG. 7G, there is shown a variation of the S routing pattern which is known as a “crossing S.” In this case, the same two sets of five in-line rows of terminals shown in FIG. 7F, include an additional set of five terminals in a row that run in a diagonal line approximately intermediate of the other two sets of five terminals. Continuing with FIG. 7G, it is seen that in order to connect corresponding terminals of these three rows of five terminals together, it is necessary for routing path segments to cross each other in the intermediate space amongst these three sets of terminals. For example, the left hand terminal of the upper row of five at terminal 264 is shown connected to terminal 266 of the diagonal row of terminals which in turn is connected to terminal 268 which is the far right hand terminal of the bottom row of five terminals. Thus, each of these five triplets of terminals are connected together in a sequence, however, because of the arrangement of the sets of terminals, it is necessary for the routing paths to cross each other. This pattern is substituted by a standard routing plan that eliminates the need to separately route each of the terminal connections shown in FIG. 7G.

Referring now to FIG. 7H, there is illustrated a diagram of a routing pattern emulation, in which the routing pattern for connecting one pair of terminals is repeated in other pairs of terminals that share similar characteristics with the initial pair of terminals. In the example shown in FIG. 7H, terminals 278 and 280 are connected together by a somewhat serpentine path routing in order to connect the two terminals together by a specific length of path. Routing pattern emulation occurs when it is important to provide an exact length, similarly shaped, routing path between two terminals to preserve timing of signals by maintaining consistent and controlled propagation times along the circuit traces. Routing pattern emulation permits an initial or model path to be emulated or duplicated by similar pairs of terminals or the path can be duplicated in form but differ in length in order to provide specific variation in the path length between similar kinds of signal terminals. FIG. 7H thus shows the routing pattern connecting terminals 278 and 280 is emulated in the succeeding four pairs of terminals. In the second pair of terminals proceeding from the left, the initial routing pattern is exactly duplicated; and in the third pair of terminals the routing pattern is similar in form but it is longer by having an additional loop built into the routing pattern. Similarly, the fourth and fifth pairs of terminals have differing lengths of a routing pattern path, yet the path is routed in a manner very much like the initial path shown connecting terminals 278 and 280.

All of the routing patterns described in FIG. 7 provide some illustrative ways to simplify the routing planning by substituting standard routing patterns for similar routing patterns that occur repetitively in a particular circuit to be routed. Moreover, such standardized routing patterns enable relatively complex patterns that occur among groups of terminals that are located adjacent each other to be routed in a standard way, reducing in the amount of analysis and routing time needed to route that particular portion of the circuit. The patterns of FIGS. 7A through 7H provide a few illustrative examples which are not intended to represent an exhaustive catalog of standardized routing patterns, but merely to illustrate the principle.

Referring now to FIG. 8A, there is shown a diagram of a routing path density contour for a portion of a routing surface. During the previously described homogenization process performed by the analysis engine 110, the density of circuit paths in unit areas of the routing surface was calculated and the resulting information stored in the density tile array file 218. This information was then used during the homogenization process which included the creation of a contour map of the routing path densities over the entire surface of the circuit to be routed. FIG. 8A illustrates a portion of the surface, in the particular example shown, of the surface located adjacent the origin of the coordinate system of the routing surface. The coordinates x and y indicate the orthogonal horizontal and vertical axes of the coordinate system of the routing surface and the third axis extending from the origin in the direction indicated by D, representing the magnitude of the path density for the individual unit areas of the routing surface. In FIG. 8A, the magnitudes of the path densities are shown as vertical columns having a square cross section representing each unit area of the routing surface. For example, the tallest such column at reference number 282 represents a path density that greater than any of the path densities of adjacent unit areas. Similarly, the column represented by reference number 284 represents a unit area having a much lower path density magnitude. All of the path densities for the entire surface are represented by this three-dimensional histogram and enables visualization of the variation in path density throughout the surface area of the routing surface.

The process of homogenization, which proceeds through the steps earlier described in conjunction with the analysis engine of FIG. 4, is the process of leveling these path density magnitudes. FIG. 8B illustrates a diagram of a cross section of a homogenized routing path density contour through a section parallel to one ordinate or axis of a routing surface. If a cross section of such a contour is viewed in two dimensions, we have the appearance of the dotted outline 286 illustrated in the graph of FIG. 8B, wherein the value D for the path density on the vertical coordinate represents the path densities for particular unit areas in a single path in the direction of the x axis. Through the steps of determining whether the homogenization is adequate as described in detail in conjunction with FIG. 4, the path densities are redistributed among unit areas so that the variation in the magnitude of the path densities is reduced to a relatively small amount. When the homogenization is complete, the contour of the path densities more closely resembles the solid line identified by reference number 288 in FIG. 8B. The criteria for determining whether the homogenization has become adequate may vary with each particular routing project to be processed by the routing system of the present disclosure. In general, the criteria will include successively repeating the homogenization process until no further significant improvement can be obtained by repeating the homogenization process. Typically, there will be some type of acceptable limits to the difference in density over the pattern.

### The Routing Zone Controller

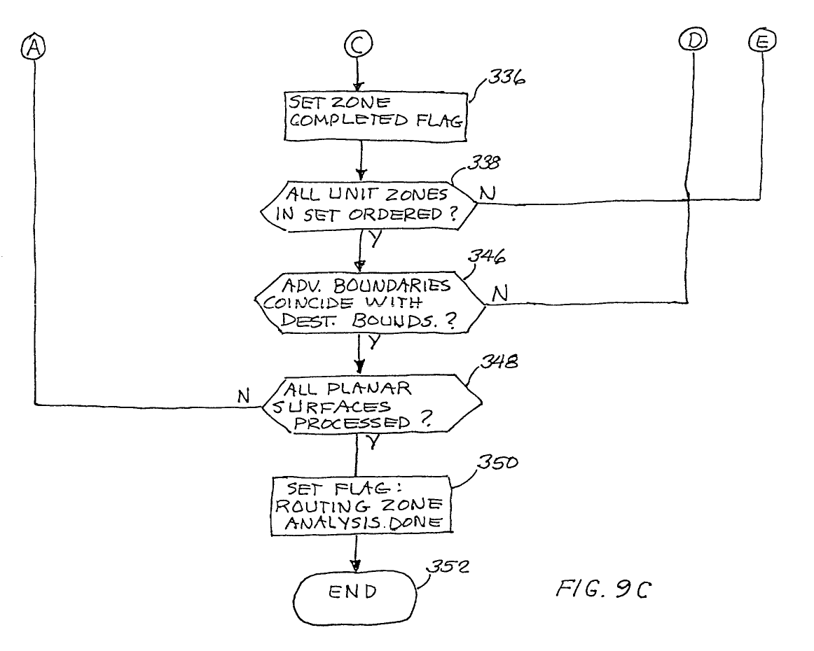

Referring now to FIGS. 9A-9C, there is illustrated the flow diagram for the routing zone analysis 300 performed by the routing zone controller 114 illustrated in FIG. 3A. The routing zone controller 114 operates on data retrieved from three different sources. Data describing the board geometry is stored in the system database 106, as illustrated in FIG. 3A. The routing zone controller 114 also obtains information from the density tile array 218 shown in FIG. 4 and also from the optimized segments file, similarly shown in FIG. 4. The essential function of the routing zone analysis 300 performed by the routing zone controller 114 is to create a routing plan that is utilized by the routing engine 118 to complete the routing of the circuit paths for the entire surface to be routed. As previously described in conjunction with FIG. 3A, the routing zone controller 114 creates routing zones for the routing plan and orders the nodes and orders the segments of each of the paths to be routed by the routing engine 118.

Referring now to FIG. 9A, there is illustrated a first portion of the flow diagram for the routing zone analysis 300. Beginning with block 302, the routing zone controller 114 starts the routing zone analysis 300 and proceeds to block 306 to create the routing zone map for each routing surface of the circuit medium to be routed. The routing zone map being created in block 306 depends upon data inputs from the board geometry in block 304 and also from the density tile array in block 218. The routing zone maps will generally be defined in the same coordinate geometry as the input board data and may include defining an advancing boundary which may initially be coincident with a reference boundary. When allowed to move systematically and uniformly away from the reference boundary toward an ultimate boundary opposite the reference, zone quanta, into which the routing surfaces may be divided, may be successively exposed and ordinal numbers assigned to each zone quanta. In the description which follows of the flow diagram for the routing zone analysis 300, the steps of the routing zone analysis 300 will be described using examples that are illustrated in FIGS. 10A, 10B and 11C. Further, several terms will be used during the description of the routing zone analysis 300 which may be used interchangeably. For example, the term “routing zone” refers to a portion of the surface area to be routed, which may have defined boundaries and which portion may also be referred to as a “unit zone” or a “zone quanta.” Thus, while a routing zone may be a subdivision of the surface area to be routed, the terms “unit zone” or “zone quanta” may also be thought of as further subdivisions or incremental units of the routing zone. In the description and illustrations to follow, routing zones or zone quanta or zone quanta are shown as having a square shape. However, such zones may be any shape and square zones are described herein for illustration purposes and not intended to limit the zone shape to square ones only.

The concept underlying the idea of unit zones or zone quanta is that, by subdividing the routing surface to be routed into relatively small zone quanta, the complexity of the routing task in a given zone quanta is considerably reduced. It will be appreciated that defining the zone quanta small enough such that the number of routing paths to be implemented and the number of nodes for which connections are to be made is reduced to a small number, the analysis required to plan the routing and the task of implementing the actual routing of the circuit paths is considerably simplified. Moreover, by reducing the size of the zone quanta, the possibility that obstacles will interfere with the routing zone analysis and the routing engine 118 operation is further minimized. Another possible consequence of using the routing zone is that a given routing path on the circuit to be routed may, through a constraint defined by the user, be confined within the zone quanta boundaries through which a straight line connecting two terminals passes. In this way, a routing path approximating a straight line could be produced, which represents the shortest possible routing path length between the start and destination nodes. The essential step is that in step 306 the routing zone controller 114 creates a routing zone map made up of zone quanta defined for each routing surface of the circuit to be routed. A user may elect to constrain a routing path within a particular row of zone quanta defined for the routing surface, for example.

Before proceeding with the description of the step of creating a routing zone map for each routing surface, block 304, which represents the board geometry data provided along with the routing constraints, the placement diagram and the net list as inputs to the routing system, will now be described. Block 304 shown in FIG. 9A includes the physical description of the circuit medium to be routed defined in terms of, in this illustrative example, a rectangular coordinate system referenced to an origin. It will be appreciated that the circuit medium, for example, a printed circuit board, may be provided any coordinate geometry, which may be oriented in any particular direction. Further, the origin may be defined at any particular point on the circuit board. In the description which follows, the illustrative example described is a printed circuit board for an electrical circuit. However, it will be appreciated by those skilled in the art and in analogous arts, that the principles of the routing system to be described in the present disclosure are applicable to any field in which the routing of information, signals, goods, or people is required by any of various means such as circuits, communication links, shipping routes in air, on land or sea, and even for example, the movement of raw materials or finished goods in a manufacturing environment.

In the illustrative example, the printed circuit board will be assumed to be a rectangular shape with the longer dimension oriented from the left to the right and the origin specified as being in the lower, left hand comer of the board. In a rectangular coordinate system, the horizontal axis extends from left to right and passes through the origin; similarly, the vertical axis extends from near to far, also passing through the origin at right angles to the horizontal axis. The horizontal axis additionally will be arbitrarily defined as the primary boundary of the printed circuit board and the vertical axis will be arbitrarily defined as the secondary boundary of the printed circuit board. The location of all of the components and the terminals are defined in coordinates of this rectangular coordinate system for this particular printed circuit board. The net list is a list of all of the terminals of all the components and the corresponding connections between them. The primary and secondary boundaries along with the origin of the printed circuit board, will serve as the reference for all of the operations of the routing zone controller 114. Every path to be routed on the circuit board is defined in terms of a segment which is an ordered pair of nodes; that is, the segment is defined in terms of two nodes, for example, a start node and a destination node. It is also possible that each of the two nodes could be a target or a terminal. Each node is defined as a point on the surface to be routed expressed in terms of its coordinates in the rectangular coordinate system. As paths are routed, the paths are defined in terms of segments. Each segment advanced during the routing zone analysis 300 and the operation of the routing engine 118, can be generally thought of as a very small, incremental extension of the routing path from one point to the subsequent point along the heading of the path. As the routing zone analysis for the routing engine 118 proceeds in its operation, the path is set to advance in its ordered direction along the heading, segment by segment.

Continuing now with FIG. 9A, in block 306 the routing zone controller 114 creates the routing zone map for each routing surface of the circuit board to be routed by dividing the board into unit zones or zone quanta, defining the initial zone quanta and a pair of advancing boundaries to be advanced during the routing zone analysis and the routing process. The advancing boundaries are imaginary lines which may initially be co-linear with the horizontal and vertical axis of the rectangular coordinate system. Similarly, the primary advancing boundary may be co-linear with the secondary axis and advances away therefrom in the direction of the primary boundary. Likewise, the secondary advancing boundary may be co-linear with the primary axis and advances away therefrom in the direction of the secondary boundary. As the routing zone analysis begins and continues from the origin of the circuit board, these advancing boundaries move away from the secondary and primary boundaries, respectively. As these advancing boundaries move away from the secondary and primary boundaries, they scan the surface to be routed and can be thought of as progressively revealing or exposing the unit zones or zone quanta of the routing surface along with the routing path or segment data associated with the particular unit zone or zone quanta that is being revealed or exposed.

In the previous paragraph, the concept of unit zones or zone quanta defined for a rectangular coordinate system was introduced. In such a system, the zone quanta may be rectangular or they may be some other shape such as circles or rhomboids, etc. The zone quanta may also be defined in a different geometry or coordinate system. The important aspect is that the zone quanta are small and typically of the same size. As will be described, the process begins with exposure of a zone quanta at an origin and expands across the routing surface, zone quanta-by-zone quanta, somewhat in the manner of a growing fungus spreading through a medium.

Also accessed by the routing zone controller 114 as the advancing boundaries move through the area represented by a zone quanta is data representing the routing constraints and the physical location of the components to be mounted upon the circuit board surface, many of which represent obstacles to the circuit paths which will be routed in the particular zone. Thus, it should be understood that creation of a routing zone map consisting of the zone quanta defined for the routing surfaces to be routed also provides a mechanism for associating various kinds of data that will be utilized by the routing zone controller 114 and the routing engine 118 during the operation of the routing system disclosed herein. One may also visualize that as the advancing boundaries move across the routing surface to be routed, each path routing segment which is being processed advances incrementally within the particular zone quanta accessed at the particular instant. The advancing boundaries collectively appear to behave as though they were moving fronts, pulling the incremental extensions of the routing paths within each zone quanta behind the respective advancing boundaries. The segments defined in each zone quanta are processed in sequence, in time-multiplexed fashion, as the routing zone analysis is performed. The sequence for processing the segments will be described more fully in the description of FIG. 9B hereinbelow. With this overview of the operation of the routing zone controller 114, the description of the flow diagram in FIG. 9A will now continue.

Following creation of the routing zone map in block 306, the flow proceeds to block 308 where the routing zone controller 114 assigns ordinal numbers to each zone quanta, which is illustrated in FIGS. 10C and 10D. FIGS. 10C and 10D show a portion of a routing surface 355 and two different ways of assigning ordinal numbers to the zone quanta. These zone quanta are illustratively shown as square or rectangular shapes, as the advancing boundaries scan across the routing surface of the circuit board being routed. In FIG. 10C, the primary advancing boundary is represented by the reference number 362 as a dotted line. Similarly, the secondary advancing boundary is represented by reference number 364 as a dotted line. The arrow at the end of each of these advancing boundaries denotes that these boundaries are moving in the direction indicated by the arrows as the processing proceeds. The primary advancing boundary 362 is moving in the horizontal direction from left to right, along the primary boundary. Similarly, the secondary advancing boundary 364 is moving along the direction of the secondary boundary from near to far in the direction of the arrows.

In this illustrative example, the first zone quanta to be revealed or exposed by the movement of the advancing boundaries as they proceed from the origin of the circuit board is zone quanta number 1 shown as the small square 366 in the lower, left hand comer of the portion 35 of the circuit board illustrated in FIG. 10C. In FIG. 10C, ordinal numbers for the zone quanta previously assigned according to a particular rule specified by a user, illustrate one scheme for ordering the routing process. When the advancing boundaries have fully exposed zone quanta 1 represented by square 366 in the lower, left hand comer, the routing zone controller 114 processes the routing zone analysis in relation to the zone quanta assigned ordinal number 1. Similarly, as the advancing boundaries move a distance equal to the dimensions of a zone quanta in this example, three additional zone quanta are revealed. The zone quanta among this group of three having the lowest ordinal number is the one closest to the primary edge of the circuit board. Thus, the zone quanta immediately to the right of zone quanta 1 represented by small square 367 has the ordinal number 2. The next zone quanta in this group of three to receive an ordinal number is the one adjacent the secondary boundary which is the zone quanta immediately above zone quanta 1 and along the secondary boundary. This zone quanta has ordinal number 3. The third zone quanta in the set, at the diagonal extremity of the area of the board that has been revealed by the advance of the advancing boundaries being diagonally adjacent zone quanta 1, has zone quanta ordinal number 4. This same pattern of ordinal numbers may be followed as the advancing boundaries move away from the origin, revealing a group of zone quanta generally arranged in an inverted L-shape as the advancing boundaries move away from the origin. The number of zone quanta within each group to be revealed will increase until the advancing boundaries have revealed approximately half of the total area of the routing surface to be routed. Thereafter, the number of zone quanta within each group to be revealed will decrease as the destination of the advancing boundaries is approached.

Referring now to FIG. 10D, the advance of the advancing boundaries for the portion of the routing surface 355 proceeds as in FIG. 10C; however, the ordinal numbers may be assigned in a different sequence which follows the advance of a single imaginary diagonal having a negative slope, which extends across the board between the primary and secondary boundaries and moves in a direction along a line from the origin to the intersection of the primary and secondary advancing boundaries. Such an imaginary diagonal advancing boundary might extend from the point 361 to the point shown in FIG. 10D, for example. Thus, after the first three zone quanta ordinal numbers are assigned, the ordinal numbers proceed from the primary boundary in order toward the secondary boundary in a diagonal path. FIGS. 10c and 10d illustrate two possible examples of the assignment of ordinal numbers and are not intended to be limiting of the ways in which ordinal numbers may be assigned.

Returning now to FIG. 9A, after the assignment of ordinal numbers to each zone quanta in block 308, the flow proceeds to block 310 where the routing zone controller 114 formats the data in the routable segment file to each of the routing zones created for the routing surface. The routable segments file is a file set up to store the routing plan for each of the segments produced by the routing zone controller 114 during the routing zone analysis. Thereafter, the flow proceeds to block 312 where the routing zone controller 114 defines the primary and secondary advancing boundaries, as previously described. Thereafter, the flow proceeds to block 314 where the routing zone controller 114 defines the destination position of each of the primary and secondary advancing boundaries which are respectively called the third and fourth destination boundaries. Proceeding then from block 314, the flow continues to block 316 where the primary and secondary boundaries are advanced to reveal the first set of zone quanta proceeding from the origin.

Referring now to FIG. 9B, the flow continues along the path designated by the encircled letter B proceeding to block 318 where the routing zone controller 114 operates to retrieve routing segment data for the present zone quanta. This is the point in the operation of the routing zone controller 114 at which the development of the routing plan begins. The routing segment data for the present zone quanta is retrieved from the optimized segments file shown in FIG. 9B as block 224. This block 224 was previously described during the description for FIG. 4.

Continuing with FIG. 9B, the flow proceeds from block 318 to block 320 where the routing zone controller 114 assigns the routing segments in the particular zone being analyzed in a sequence in which the routing will take place. This information is held in routing sequence queues until further use. In block 320, the sequence in which segments will be routed is determined according to specific rules. A variety of rules may be used. These rules will generally be in the form of an algorithm for determining the sequence that is necessary. The particular algorithm employed depends upon what kind of routing is being performed by the routing system.

In the illustrative example, one such rule or algorithm will be described as follows. The segments to be routed may be ordered or processed first, in the order of decreasing relative position along the advancing direction corresponding to the segments' primary orientation. This means that in a particular zone quanta, the first segment to be processed is the one that has its beginning node closest to the primary boundary and the closest to the advancing boundary. Thus, the node that is both the closest to the primary boundary or the horizontal edge of the board and closest to the primary advancing boundary that is the boundary that advances in the direction of the primary boundary, will be the first one to be processed. Further, the processing will proceed in the direction of that particular segment, according to the order of the nodes that define that segment. The second rule for determining the sequence of the segments is that the processing or ordering of the segments proceeds in the order of the decreasing relative position along the direction which is perpendicular to the primary orientation.

The effect of these two rules is to imagine standing on the primary advancing boundary and looking to the left. The first node that is closest to the primary advancing boundary is the first node to be processed, whether it is a node that begins a segment that is ordered horizontally or vertically. If two nodes that begin routing segments happen to be equally spaced from the primary advancing boundary, the first of the two that will be processed is the one that is closest to the primary boundary. Similarly, if several nodes are located on a line that runs perpendicular to the advancing boundary, the first node to be processed will be, of course, be the one closest to the advancing primary boundary. The operation of this particular illustrative algorithm for determining the sequence of the segments to be routed will be described again in detail with respect to FIG. 15 hereinbelow. To summarize, the operations performed in blocks 318-332 of FIG. 9B represent the basic process of the routing zone controller 114 in performing the routing zone analysis 300 to create the routable segments file in block 322.

Continuing with FIG. 9B, the flow proceeds from block 330 to block 320 where the routing zone controller 114 will determine the direction the instant segment in the instant zone quanta is to be routed. This determination is made by examining the coordinates that define the segment, which coordinates are specified in the order in which the segment will be routed. For example, a segment is defined by its end points, i.e., the nodes at each end of the segment. The first coordinates given in the expression for a segment specify the beginning point or the node which begins the segment. The second coordinates given identify the location of the destination point or the node at the end of the segment. Since each of the segments is oriented parallel either to the primary edge or to the secondary edge, (or, parallel or perpendicular to a single reference edge) and the fact that the coordinates for any given point are specified as two numbers, the direction of the segment can be determined by comparing the one coordinate of each end of the segment which changes. It will be appreciated that in some coordinate geometries defined for the routing surfaces the directions allowed for the segments to be routed will not be always parallel or necessarily permitted only in perpendicular directions. However, it will usually be true that routing paths will proceed parallel to each other in the same direction and change direction at the same angle.

The flow proceeds in FIG. 9B from block 322 to block 324 where the routing zone controller 114 advances the segment. If there is not a target node in that direction specified in the coordinates in the segment that is being routed, it will advance in that direction toward the zone boundary, and from that step, proceed to block 332.

Continuing with FIG. 9B, in step 332, the routing zone controller 114 then determines whether all of the segments from the optimized segments file in block 224 have been written to the routable segments file in block 326. If the result is negative, the flow proceeds to block 334 along the “N” path, where the routing zone controller 114 proceeds to the next segment, that is the flow returns to block 318 to retrieve the next segment data for the particular zone quanta being analyzed. If however, all of the segments in that zone quanta have been written to the routable segments file, the flow proceeds along the “Y” path identified by the encircled letter C at the bottom of FIG. 9B, to block 336 shown in FIG. 9C, where the routing zone controller 114 sets the flag that indicates that routing zone analysis for that particular zone has been completed. Thereupon, the flow proceeds to block 338 where the routing zone controller 114 determines whether all of the zone quanta in the present set of zone quanta of the routing surface have been ordered. It will be recalled that a set of zone quanta is the group of zone quanta which are revealed in full by the advance of the advancing boundaries, as described for FIGS. 10C and/or 10D. If all of the zone quanta in the set have not been ordered, the flow proceeds along the “N” path and identified with the encircled letter E to block 340 which is located at the top of FIG. 9B, where the routing zone controller 114 determines whether there is another zone quanta in the set. If yes, there is another zone quanta in the set, the flow proceeds along the path labeled with a “Y” to a block 342 where the routing zone controller 114 shifts the routing zone analysis to the next zone quanta in the set and from there proceeds to block 318 to retrieve the segment data corresponding to that zone quanta. Returning to block 340, if the determination is that there is not another zone quanta in the set, the flow proceeds along the path labeled “N” from block 340 to block 344. In block 344, the routing zone controller 114, having determined that no other zone quanta in that particular set remain to be analyzed, will advance the primary and secondary boundaries to the next zone set. When that advance is complete, the routing zone controller 114 proceeds to retrieve the segment data for the first zone quanta to be processed within that particular zone quanta set.

Returning now to FIG. 9C, the description continues with decision block 338, where the routing zone controller 114 determined whether all the zone quanta in the particular set have been ordered. In the event the answer is affirmative, the flow proceeds along the path labeled “Y” to block 346 which is another decision block to determine whether the advancing boundaries coincide with the destination boundaries. In the event the advancing boundaries do not coincide with the destination boundaries, that is, the routing zone analysis has not yet been completed, the flow proceeds along the path labeled “N” which is also identified with an encircled letter D and the flow proceeds along this line on FIG. 9B to a block 344 in FIG. 9B, where the routing zone controller 114, as previously described, advances the primary and secondary boundaries to the next zone set. Returning to block 346 in FIG. 9C, if the advancing boundaries do coincide with the destination boundaries, all of the zone quanta for the entire routing surface to be routed have been fully analyzed by the routing zone controller 114 and the routing zone analysis 300 is complete for each of the zone quanta in the surface to be routed. Thereupon, the flow proceeds along the path labeled “Y” to a decision block 348 wherein the routing zone controller 114 determines whether all of the routing surfaces in the circuit board to be routed have been fully processed. If the result is negative, that is, there are surfaces remaining in the circuit board that have not yet been fully processed, the flow proceeds along the path labeled “N” and further identified in FIG. 9C by an encircled letter A, which proceeds through FIG. 9B and back to FIG. 9A, where the flow returns to the beginning of the routing zone analysis program at block 306. If however, returning to FIG. 9C, the routing zone controller 114 determines that all of the routing surfaces have been processed, the flow proceeds along the path labeled “Y” from decision block 348 to block 350 where the routing zone controller 114 sets the flag that indicates that the routing zone analysis is completed for the entire circuit board. The flow then proceeds to block 352 which is the end of the routing zone analysis.

Referring now to FIGS. 10A and 10B together, the creation of the unit routing zones will be described. In FIG. 10A, the reference number 354 indicates that FIG. 10A illustrates a rectangular shape printed circuit board to be routed. Defined on this printed circuit board routing surface is an origin identified by reference number 360 and labeled with a letter 0. As previously described, the routing surface to be routed is also defined with a primary boundary 356 and a secondary boundary 358. There are further defined on the routing surface 354 a primary advancing boundary 362 and a secondary advancing boundary 364. These two advancing boundaries further define, as they move across the board, a region of the routing surface that is exposed by this movement of the advancing boundaries indicated by reference number 366 and the heavy lines corresponding to the positions of the respective advancing boundaries. The movement of the advancing boundaries defines the progression of the operation of the routing zone controller 114 as it performs the routing zone analysis 300 while orderly scanning the routing surface to be routed from the origin to the destination. In FIG. 11B, the same routing surface of a circuit board is illustrated, identified by reference number 354 and shown with the advancing boundaries 362 and 364 in a more advanced position that reveals several zone quanta which have been processed during the routing zone analysis. In FIG. 11B, the advancing boundaries are shown as dotted lines for clarity. The zone quanta, indicated by reference number 366 as an example, are all defined in the same way so that all of the zone quanta are the same size, as indicated in FIG. 10B. Thus, reference number 366 properly indicates that the zone quanta at the origin is representative of all of the zone quanta that are exposed by the advance of the advancing boundaries shown in FIG. 10B. FIGS. 10C and 10D, which illustrate the assignment of ordinal numbers to the zone quanta as they are successively revealed or exposed by the advance of the advancing boundaries, were previously described during the description of FIGS. 9A, B and C and will not be further described here.

Before the third major element of the routing system of the present disclosure is described in detail, it will be helpful to examine some details of the routing zone analysis and the effect of some of the enhancements that are provided in the routing system of the present disclosure.

Referring now to FIG. 11A, there is illustrated a portion of a routing surface to be routed for three segments within a particular zone quanta. In the particular example of FIG. 11a, the zone quanta 368 is shown at the origin and bounded by the primary boundary, the secondary boundary, the primary advancing boundary at 376 and the secondary advancing boundary at 378. The segments to be routed, representing data obtained from the optimized segments file, are shown as node pairs designated by unprimed and primed capital letters. The segments are designated A-A′, B-B′, and C-C′. The point-to-point routing path for each of the segments is shown as a dashed line in FIG. 11a. During the operation of the analysis engine, these segments are reduced to the orthogonalized equivalents of the particular segment as shown in FIG. 11b, which illustrates the result of the orthogonalization process showing the orthogonal paths and the target nodes defined for each of the path segments. For example, segment A-A′ is shown as orthogonal segments proceeding from node A to target node 370 and from target node 370 to node A′. Similarly, segment B-B′ is shown in its orthogonal component form as a routing segment from node B to target node 372 and from target node 372 to node B′. Further, segment C-C′ is shown in its orthogonal form as the routing segments from node C to target node 374 and from target node 374 to node C′.

Referring now to FIG. 11C, there is illustrated the manner in which successive portions of the routing surface are revealed as the zone quanta created by the advance of the advancing boundaries. In this representation of the zone quanta shown in FIGS. 11A and 1B, the primary boundary and the secondary boundary are marked in units, for example, labeled a, b, c and d, to indicate possible successive positions of the advancing boundaries as they move across the board away from the origin. Thus, at the dotted line corresponding to distance “a” in both directions, a dotted line shows the positions of the advancing boundaries at that instant. Similarly, at the other dimensions b, c and d, the positions of the advancing boundaries are shown. It will be appreciated as the advancing boundaries move, a correspondingly larger area of the zone quanta surface is exposed to the routing zone analysis by the routing zone controller 114 until the midpoint of the advance beyond which the area exposed progressively diminishes.

Continuing now with FIG. 11D, there is illustrated a particular process that is performed during the routing zone analysis, wherein the path segments are advanced incrementally corresponding to the advance of the advancing boundary. FIG. 11D illustrates the same primary boundary and second boundaries along with the advancing boundaries 376 and 378, and the designation of the zone quanta of interest as reference number 368. Similarly, the segments to be routed are identified as A-A′, B-B′ and C-C′. During the routing zone analysis, the order of the nodes is defined by the coordinates in the expression for each node, and the order of the routing of the segments or the sequence of the routing, proceeds by the set of rules described earlier. In FIG. 11D, the incremental advance of the segments of the path segments to be routed proceeds in the order hereinafter described. In this example, it will be assumed that a zone quanta is defined by the units a, b, c and d marked on the primary and secondary boundaries. For example, zone quanta 1 is the zone quanta bounded by the primary and secondary boundaries and the dotted line that corresponds to the unit dimension designated with a dimension “a.” The second set of zone quanta is designed as the space between dimensions a and b corresponding to successive positions of the advancing boundaries 376 and 378, indicated by the dotted lines extending perpendicularly from each of the primary boundaries, until the two dotted lines intersect. Thus, as we previously saw in FIGS. 10C and/or 10D, three zone quanta are created in the second set of zone quanta when the advancing boundaries completely reveal that particular area. Similarly, successive sets of zone quanta are revealed as the boundaries move to the position indicated by dimension “c” and also by dimension “d,” which indicates the exposure of the fourth set of zone quanta.

Continuing with FIG. 11D, all of the nodes involved in specifying the routing segments for segments A-A′, B-B′ and C-C′ are shown. There are no nodes or segment increments present in the first zone quanta bounded by the dotted line indicated by dimension “a.” However, there are several nodes identified in the set of zone quanta between dimensions “a” and “b.” As the zone quanta sets are revealed, the segment paths are incrementally advanced in that particular zone quanta in the direction indicated by the coordinates of the nodes that comprise that particular segment. Further, the order in which the segments are routed proceeds according to the rules described earlier. The purpose of FIG. 11D is to illustrate that when a segment approaches a boundary of a zone quanta, an interim node is defined in order to position that segment for the routing zone analysis that will occur in the succeeding zone quanta in that same direction. For example, looking at segment A-A′, the routing direction is shown as proceeding from near toward far in parallel with the vertical direction or the secondary boundary and as the segment crosses the position of the advancing boundary at b, an interim node 371 is defined. When the routing zone analysis for the succeeding zone in order to complete the advance of the path from node A to target node 370, the processing will proceed from interim node 371 until it reaches target node 370, at which time the path segment will be defined by the coordinates of node A and target node 370, and will no longer need to have the interim node 371 defined as part of the routable segments file information. Similarly, segment B-B′ is comprised of node B, target node 372 and interim nodes 375 and 377, as the segment is routed in the orthogonal directions from node B to target node 372 to node B′. Likewise, segment C-C′ is routed orthogonally from node C to target node 374 and then to node C′ wherein an interim node 379 was used to identify the position of the segment as the advancing boundary crossed from the zone quanta that contained the part of the segment extending to the right from target node 374 until the successive zone quanta containing node C′ could be defined and analyzed by the routing zone controller 114.

Referring now to FIG. 11E, there is illustrated the orthogonalized path segments as they will be routed by the routing engine 118. The nodes defining the position of the segments which, after routing are designated as edges, are defined by the filled-in circles or the black dots connected by the solid lines indicating the actual routed circuit paths on the routing surface.

In the preceding description, FIGS. 11A-11E illustrate a simplified example of planning the routing of a circuit on a portion of a routing surface, i.e., the allocation of circuit path segments within the respective zone quanta of the routing surface. The example describes the routing of three routing path segments within a single zone quanta followed by routing the plan for the segments within that zone quanta. The zone quanta described could be anywhere on the circuit board surface; in the illustrations of FIGS. 11A-11E, the first zone quanta next to the origin was used as a matter of convenience.

Several other observations may be made about the routing zone analysis illustrated in FIGS. 11A-11E. FIGS. 11A and 11B illustrate the operation in the analysis engine 110 wherein the path segments from the net list are resolved into their orthogonal components within a zone quanta; however, at this point in the operation of the routing system, the zone quanta boundaries and the advancing boundaries have not yet been defined. FIGS. 11C and 11D show how the advancing boundaries might reveal a portion of the circuit board, including several successive sets of zone quanta, in which the routing path segments are advances incrementally within each zone employing both target nodes and interim nodes in order to define the point-to-point connections along each path segment. Thus, FIGS. 1C and 11D illustrate the routing zone analysis performed by the routing zone controller 114. FIG. 11E, shows the path segments as they would be routed by the routing engine 118 following the routing zone analysis for the particular zone quanta in which the segments are defined.

It has been mentioned previously that the routing system 100 of the present disclosure combines the analysis performed by the analysis engine 110, which includes the orthogonalization and homogenization and pattern recognition analysis of the routing path segments, followed by the routing zone analysis which allocates the circuit path segments and plans the routing for all of the path segments on a zone quanta basis. The zone quanta concept enables both the analysis and the actual routing to take place in a defined zone quanta of limited area, wherein the number of routing path segments to be processed and the number of obstacles to routing the path segments are reduced because of the small size of the zone quanta. However, the zone quanta dimensions are not reduced so far as to eliminate all path conflicts and path density issues Empirically, there is a range of useful zone quanta dimensions that will permit efficient routing within the constraints provided for the particular routing problem.

Returning briefly to a discussion of prior art routing methods, it was previously mentioned that the prior art routing methods typically route each path in its entirety regardless of its length on the circuit board. As a consequence of trying to route the entire path, many paths may have to be re-routed during the latter part of the job because the obstacles to routing the entire path may have become too complex and too numerous to efficiently route all of the paths on the circuit board in this manner. As is often the case, the routing of entire paths is relatively straight forward in the early part of the routing process; but as the circuit board layout proceeds and more and more of the paths are defined and routed, problems of path conflict and path density increase. Thus, while the prior art system may be efficient in the early stages of the routing process, the efficiency falls off rapidly as more and more of the circuit paths are routed on the surface.

The routing task for the routing system and method of the present disclosure is essentially a statistical maze problem as compared to the routing task presented by the typical prior art routing system which is to find a path in a physical maze. In the case of the routing system of the present disclosure, routing through a statistical maze is a trivial issue for a high speed computer; however, the level of difficulty for performing routing in a physical maze is a non-trivial problem even for a computer. The use of the physical maze is required in the prior art in order to efficiently define the parameters to enable routing of the circuit paths. In contrast, a larger grid, even though it is a relatively small unit area compared to the entire board, allows the use of the statistical maze routing enabling the computer to operate at its maximum efficiency. In effect, it is allowing the computer to find numerical solutions to a statistical problem which is a trivial operation for a high speed computer. As a result, the routing system 100 of the present disclosure is approximately an order of magnitude times faster than the routing system of the prior art methods.

Referring now to FIGS. 12A and 12B, there are shown two examples for dividing the circuit surface into regions to be routed separately to enable routing of portions of the circuit board surface in parallel, thus faster, more efficient routing of the circuit paths. The routing system of the present disclosure lends itself to parallel processing to provide further increases in the speed with which circuit paths may be routed. FIG. 12A illustrates parallel processing by dividing the area to be processed among several processors. In the example shown in FIG. 12A, a region identified by reference numeral 400 is divided by two orthogonal axes, a horizontal axis 402 and a vertical axis 404. These axes cross at reference number 406. Since the region 400 to be routed is described in terms of rectangular coordinates, it is a simple matter to redefine equal sized portions of that region for separate processing by individual processors. As an example, in FIG. 12A is shown a routing segment from A to B, initially defined in a single area, but when divided into four separate areas, presents the same routing problem defined into three subunit areas. Each subunit which is then individually processed presents a subset of the individual routing problem of connecting node A to node B. During the orthogonal step, a target node is defined at node 408 shown by the small triangle in the upper left hand subunit. As the routing segment is advanced from node B to target node 408, an interim pair of nodes is defined at the boundary that separates the adjacent subunits processed by separate processors. This pair of nodes is identified by the reference numeral 410. Similarly, in the connection of node A to target node 408, another pair of nodes is defined at a boundary between the two adjacent subunit areas to be routed by separate processors designated by reference numeral 411.

Referring now to FIG. 12B, there is illustrated another example of a region for parallel processing of a routing surface to be routed that is divided into four equal sized subunits by horizontal and vertical lines 402 and 404 that intersect in the center of the region 400 at a point 406. In this example of region 400 shown after the routing zone analysis has been completed by the routing zone controller 114, the region may be subdivided as shown and the routing can proceed within each subunit by separate routers designated for each subunit. The individual routers begin their operations at a node defined anywhere on the boundary between two subunit areas and advance away from the boundary as shown by the arrows in FIG. 12B, one arrow pointing to the right designated with the letter E, the other arrow pointing to the left designated with the letter W. Each of these arrows represents the operation of an individual router beginning its routing operations on the boundary 404. The examples illustrated in FIG. 12A and FIG. 12B are for illustrative purposes and represent only two of the number of possible ways to parallelize the operations in various parts of the routing system of the present disclosure.

### The Routing Engine

Referring now to FIG. 13A, which provides the first portion of a flow diagram for the routing engine 118 as shown in FIG. 3A, there is described the process for connecting the routable segments within each zone quanta of the routing surface to be routed using the routing system of the present disclosure. The routing engine 118 is initiated within each zone quanta at the completion of the routing zone analysis 300 by the routing zone controller 114 in response to the flag that was set by the routing zone controller 114 in step 350 in FIG. 9C. The flow proceeds from block 414 to block 416 which is a decision step wherein the routing engine 118 determines whether there are any routable segments in the routable segments file 322. It will be recalled that the routable segment file 322 is the repository for all of the segment data that resulted from the routing zone analysis 300 in FIG. 9B at block 322. If the routing engine 118 determines that there are routable segments in the routable segments file, the routing engine 118 advances along the path labeled “Y” to block 418 where the routing engine 118 will retrieve the next routing segment from the routable segments file 322 and advance the pointer indicating that the routable segment has been retrieved from the routable segments file 322. Thereafter, the flow proceeds to block 420.

In decision block 420 the routing engine 118, which must begin processing a segment at the location of a start node or a terminal, determines whether the first (start) node of this first segment is a terminal or is not a terminal. If the answer is negative, then the flow proceeds along the path labeled “N” to the block 422 to advance to the next node, at which point the flow returns to the input side of the decision block at 420. If, however, the result of the decision at block 420 is affirmative, then the flow proceeds to block 424. That is, if the first node of the segment to be routed is on a terminal, then the segment advanced is said to escape to the closer of the next boundary or the next target node. Thus, the routing engine 118 at block 424 determines which is closer, the boundary of the zone quanta or the next target node. If the target node is the closest defined point in the intended path, then the routing engine 118 fetches the target node at block 428 and then proceeds in block 430 to establish the heading of the routing segment that is being routed. On the other hand, if, in block 424, it was determined that the boundary of the zone quanta is closer, then the flow proceeds along the path with the letter B to block 426 where the routing engine 118 then fetches the coordinates of the target which is at the path boundary junction. The flow thereupon proceeds to the input of block 430 where the routing engine 118 establishes the heading of the path segment to be routed toward the ultimate coordinate location of the destination of the routing path. The flow thereupon proceeds to block 432 where the routing engine 118 locates the second node of the segment to be routed in the direction of the heading of the path segment.

Continuing with FIG. 13A, the next step in the operation of the routing engine 118 is to determine whether in decision block 434 there is an obstacle in the intended path of the routing segment to be routed. If the result is negative, then the flow proceeds along the path labeled “N” to block 436 where the routing engine 118 proceeds to advance the segment in the heading determined by the coordinates of the segment. Flow then proceeds along the path to block 438 where the routing engine 118 makes the connection between the two nodes defining the segment and stores the data representing that segment, that is, the coordinates of the end points in the system database. The flow then proceeds along the path indicated by the encircled letter C where the path is continued on FIG. 13B and proceeds to the decision block labeled with number 440. Therein, in block 440 the routing engine 118 determines whether the zone that it is operating in has been completely routed. If the result is no, then the flow proceeds along the path labeled “N” and identified by the encircled letter B, returning to FIG. 13A and thence to block 418 to retrieve the next routing segment and advance the pointer and continue through the flowchart steps illustrated in FIG. 13A.

Returning now to decision block 440, if it was determined by the routing engine 118 that the zone quanta within which it is operating has not been completely routed, then the flow proceeds along the path labeled “Y” to block 442 where the routing engine 118 advances to the next zone. The flow thereupon proceeds to decision block 444 where the routing engine 118 determines whether both the primary and secondary zone boundaries have fully advanced across the zone quanta of current interest. If the result is no, that is, the zone boundaries have not fully advanced, then the flow proceeds along the path labeled “N” and identified by the encircled letter A which continues on FIG. 13A to block 474 where the routing system enters the process at the beginning of the routing zone analysis 300 for the next zone. Thereupon completing the routing zone analysis 300 for the next zone quanta, the flow proceeds to the input of decision block 416 and the flow repeats through the routing engine 118 flowchart.

Returning now to FIG. 13B and decision block 444, if it was determined that both the primary and secondary zone boundaries are fully advanced so that they coincide with the destination boundaries defined and described previously, then the flow proceeds along the path labeled “Y” to block 446 where the routing engine 118 transfers all of the routing connections to the system database 106. The flow then proceeds to block 448 where the routing engine 118 sets a flag indicating the routing has been completed and the flow then proceeds to the end of routing block at reference block 450.

Resuming the description with FIG. 13A and block 416 which is the decision block wherein the routing engine 118 determines whether there are any routable segments in the routable segments file, and the result is found to be no, the flow proceeds along the path labeled “N” to block 476 where the routing engine 118 determines whether the zone boundaries have fully advanced to the next zone. If the result is negative, then the routing engine 118 advances the zone boundaries to the next zone in block 478 and returns to decision block 476 to again make the determination whether the zone boundaries are fully advanced. Of course, at this point, the result of the determination in block 476 would be affirmative and the flow proceeds along the path labeled “Y” and continues along the path identified by the encircled letter E on FIG. 13B to block 446. In block 446 the routing engine 118 transfers the routing connections to the system database.

Continuing with FIG. 13A the process is picked up at block 434 where the routing engine 118 determines whether there is an obstacle in the particular path to be routed. If the result is affirmative, then the flow proceeds along the “Y” path to block 452 where the routing engine 118 employs a separate set of processes to reposition the path around the obstacle.

From block 452, the flow proceeds along the path identified by the encircled letter D to continue on FIG. 13C to a decision block 454 wherein the routing engine 118 seeks to determine whether there is a path available around the obstacle. If a path is available around the obstacle, the flow proceeds along the path identified with the letter “Y” to block 456 where the routing engine 118 initiates a routine to bypass the obstacle. Thereupon the routing engine 118 proceeds to decision block 458 to confirm whether the obstacle was, in fact, bypassed. If the result is affirmative, the flow proceeds along the path labeled “Y” to block 460 where the routing engine 118 returns to the original heading of the path segment being routed. Then the flow proceeds to block 480 to store the bypass coordinates, that is the coordinates of all of the segments and nodes involved in the bypassing of the obstacle encountered in block 434. The flow thereupon proceeds to the path identified with an encircled letter B and returns to FIG. 13A where the routing engine 118 in block 418 retrieves the next routing segment, advances the pointer and proceeds with the routing of the next segment. The routine for bypassing the obstacle in block 456 can be accomplished by several possible methods. An illustrative example of a method for redirecting the routable segment around an obstacle will be discussed in detail hereinbelow with the detailed description for FIGS. 14A-14G. Other methods of handling obstacles include repositioning the obstacle (if the obstacle is movable) and ripping the segment being routed backwards to the start node, offsetting the path and returning to the heading after the obstacle is passed.

Proceeding with FIG. 13C, in decision block 458 the routing engine 118 determined whether or not the obstacle has been bypassed. If the result is negative, the flow proceeds along the path labeled “N” to block 462, where the routing engine 118 continues to attempt to bypass the obstacle. Subsequently, the flow proceeds to decision block 464 in which the routing engine 118 determines whether the selected bypass path is blocked. If the result is negative, the flow proceeds along the “N” path to again determine whether the obstacle has been bypassed at decision block 458. If, on the other hand, the bypass path is blocked, then the routing engine 118 in decision block 464 follows the path labeled “Y” to block 466 and rips up the bypass segment so that it may begin again to find a path around the obstacle. The expression “rip up the bypass segment” refers to removing the segments routed backward to the point where the obstacle was encountered. The flow then proceeds to block 468 where the routing engine 118 proceeds to a rip and offset or jog routine to remove the segment path previously routed backward to the start node of the segment being routed.

Returning to block 454, the routing engine 118 determines whether a path is available around the obstacle that it encountered in block 434. If the result is negative, that is, a path is not available, the flow proceeds to block 468 where the routing engine 118 proceeds to a rip and offset or jog routine as previously described. The flow then proceeds to block 470 where the routing engine 118 offsets or jogs the segment path by relocating the start node to either side of the intended heading in order to branch around the obstacle. There are many ways such an offset or jog could be defined. As an illustrative but not limiting example, a short routing segment of predetermined length is defined at an angle-usually orthogonal, but not always-with the path heading from a node specified on the path heading or branching to a new location for the start node. The routing engine 118 advances in the direction of the heading, as previously described. When the advancing segment path reaches the zone boundary, the routing engine 118 returns to the original heading at the zone boundary. That is, the advancing path makes a turn and branches back to return the advancing path to the position of the original heading in block 472. From block 472, the flow proceeds along the path identified with the encircled letter B, returning to block 418 in FIG. 13A to retrieve the next segment and advance the pointer. Returning to block 458, if the result of the determination therein is affirmative, the routing engine 118 returns to the heading in block 460, followed by the operation in block 461 to store the bypass coordinates and return to block 418 in FIG. 13A.

Referring now to FIG. 14A, there is shown a portion of a circuit board surface to be routed indicated by the reference number 500 to illustrate the routing of a single path segment advancing within a zone quanta. Zone quanta 506, revealed and bounded by advancing boundary 502 and advancing boundary 504, includes the advance of a path segment from node A to node B. The advance of this path segment illustrated by the elongated rectangle 508, designated as rectangle R₁, which extends from node A to the zone quanta boundary at advancing boundary 504. The path segment from node A to node B is further defined beyond advancing boundary 504 to extend to the triangular shaped target node at node B, which path routing segment is designated by the elongated rectangle R₂ and given the reference number 510. The path rectangle labeled R₂ is shown in a dotted line to indicate that it has not yet been processed by the routing engine 118. In practice, during the operation of the routing engine 118, the incremental rectangles R₁ and R₂, each having a width equal to the etch width, may actually be comprised of a series of shorter incremental advances as the routing engine 118 processes each segment, one incremental unit at a time, in the zone quanta in the predetermined order as previously described for FIG. 9 at block 330.

Referring now to FIG. 14B, there is illustrated a zone quanta 512 in which a planned path routing segment is to be redirected around an obstacle by the routing engine 118 by a process described in the flowchart of FIGS. 13A, 13B and 13C. In FIG. 14B, zone quanta 512 is bounded by the primary edge and the secondary edge of the routing surface to be routed as well as the zone quanta boundaries 513 and 515. Extending across the zone quanta 512 in both the entire vertical dimension of the zone quanta 512 and a substantial portion of the horizontal dimension of zone quanta 512 is a previously routed edge or segment path 514. This previously routed edge represents an obstacle in zone quanta 512 around which a subsequent path segment is to be routed. It will be appreciated that any structure in the circuit may be an obstacle to some path segment, including other path segments, terminals (even terminals without connections to them), vias, etc. The preexisting obstacle path in zone quanta 512 of FIG. 14B is shown by way of illustration to illustrate how the algorithm and the routing system of the present disclosure proceeds to redirect a path segment around such an obstacle and is not intended to be limiting in any way to only this particular method of redirecting a path segment.

In this illustrative example, the path segment to be routed extends from the node 516 to node 518 within zone quanta 512. It will be assumed in this illustrative example that the particular circuit board being routed has at least two routing surfaces separated by the thickness of a substrate layer. The routing surface layer upon which the path segment to be routed has been defined is designated L1, for layer one. Similarly, the adjacent layer which may be utilized for redirecting the path segment around an obstacle is designated in FIG. 14b by L2 for layer two. As the routing advances, the path segment from node 516, which is a start node, advances in the direction of the heading, which is in the same direction as a line passing through nodes 516 and 518, until it encounters obstacle 514. Upon encountering obstacle 514, the routing engine 118 defines a new node at node 520 and redirects the path, i.e., “jogs,” by defining a new path segment running from node 520 to a new node positioned—usually orthogonal, but not always-relative to the heading node 522. In the process of defining this “jog” or offset segment, the routing engine 118 determines that the obstacle 514 is again in its path and redefines the offset node 520 as a via that connects the routing path segment on layer one to a planned routing path on the next available routing surface which may be designated layer two. The routing engine 118 again looks for the presence of an obstacle and seeing none advances the path segment from the new node defined at node 520 at the via to the offset path 522 on the second layer. The routing engine 118 then checks to determine if the obstacle has been bypassed on finding this is the case in this particular example, the routing engine 118 returns to layer one by defining node 522 as a via, and redirects the path in parallel with the original heading of the path segment between nodes 516 to 518. The routing engine 118 then continues to advance the segment path on layer one to the next target node defined at node 524 where the routing engine 118 will attempt to offset the redirection path in the opposite direction in order to return to the original heading. Upon finding the obstacle 514 continues to exist on layer one, the routing engine 118 will attempt to go to the next layer and advance the segment toward the original heading on the second layer, L2. As shown in FIG. 14B, this routing of the path on layer two is successful and returns the path to a node defined on the original heading, on layer two, subsequently establishing node 526 to define a via and the return path to layer one on the original heading of the segment. The path segment is then further advanced to the next node which is the destination node 518. At each advance of a segment path the node coordinates are updated and stored.

Referring now to FIG. 14C, there is illustrated therein an enlarged portion of several of the zone quanta shown in FIG. 10C. The portion illustrated in FIG. 14C includes a group of path segments defined in terms of their nodes, that is, the start node and the destination node for each path segment, which are defined for zone quanta number 4. In FIG. 14C, there are four zone quanta shown which correspond to the same set of four zone quanta so identified in FIG. 10C by the numeral in the lower left hand comer of each zone quanta. For example, in FIG. 14C, zone quanta 4 is shown along with zone quanta 7, zone quanta 8 and zone quanta 12. The path segments to be routed that are identified in zone quanta 4 consist of eight pairs of nodes designated by the capital letter references, for example, A-A′, B-B° C-C′, etc. through the path segment identified as H-H′. The particular letter designations assigned to each of these path segments is assigned in a particular sequence which corresponds with the same sequence in which these path segments will be routed within zone quanta 4. It will be apparent upon inspection that several path segments, specifically, path segments beginning with starting node A, starting node C and starting node E originate within zone quanta 4. It will also be observed that the remaining five path segments designated by start node B, start node D, start node F, start node G, and start node H, all of which start nodes are located on the near side horizontal boundary 528 or on the left side vertical boundary 530, indicating that each of these nodes represents a path segment that originated in the zone quanta 2 or 3 respectively. Reference is made to FIG. 14D which reproduces the essential content of FIG. 14C within the heavy line border 540 in FIG. 14D. Notice also that the portion of the routing surface being routed illustrated in FIG. 14D is identified by the same reference numeral 354 as shown in FIG. 10C.

Continuing with FIG. 14C, zone quanta 4 is shown bounded by the near side horizontal boundary 528 which is also divided into arbitrary unit increments defined as the length of one side of the zone quanta divided by ten. Zone quanta 4 is also bounded on the left side by the vertical boundary designated by the reference numeral 530 and is similarly divided into arbitrary one-tenth length dimensional units for the convenience of this illustrative example. Zone quanta 4 is further bounded by zone quanta boundary 532 which is parallel to the near side horizontal boundary 528 and also by zone quanta boundary 534 which is parallel to the left side vertical boundary 530. Zone quanta 7 and 12 are also bounded by zone quanta boundary 532 and zone quanta 8 is similarly bounded by zone quanta boundary 536. In this example illustrated in FIG. 14C the vertical advancing boundary is represented by boundary 532 and the horizontal advancing boundary is represented by boundary 534. With respect to zone quanta 4, and any other zone quanta, it should be understood that the zone is not restricted to a single or to a single plus an adjacent layer as might be inferred from the descriptions provided herein of an illustrative example. Rather, a zone quanta may include all the layers or routing surfaces that comprise the surface to be routed.

As previously described, one rule (of a variety of possible rules) for determining which path segment is advanced first and the corresponding order of the rest of the path segments within a particular zone quanta is that the node closest to the primary edge and to the advancing boundary that is moving in the same direction as the primary edge are routed first. Thus, path segment A-A′ will be advanced first within zone quanta 4 followed by path segment B-B′, then by C-C′ , then by D-D′, then by E-E′ followed by path segments F-F′, G-G′, and H-H′, it should be appreciated that, because the planning of the routing and the routing occurs zone-by-zone, each portion of the segment within the zone is advanced in turn. The remaining portions of the segments are advanced subsequently in succeeding zones to be processed. Over time all of the paths are advanced in a time multiplexed order so that all paths are effectively routed together from their respective start nodes toward their respective destination nodes, whether the destination node is within the same zone quanta or is located in a distant zone in the same heading direction as the path segment defined in zone quanta 4.

In actual practice, because of: (1) the relatively small size of the zone quanta; (2) the fact that, because of the small size of the zone quanta, the complexity of the routing problem has been reduced to a few path segments in which the routing has been previously planned by the routing zone controller 114; and (3) that fact that there are relatively few obstacles to be concerned about in routing the path segments within small zone quanta, the actual routing will occur quite rapidly within each particular zone quanta. Thus, over the small amount of time that it takes to route these path segments, the path segments appear to grow from the start node in the direction of the heading of each path segment. The appearance of the path segments advancing together within each zone quanta appears as a collection of entities which are growing in an ordered way. Further, again previously described, when a path segment is being routed into an adjacent zone quanta, the routing zone controller 114 and the routing engine 118 will define a point at the zone boundary so that the routing, when it continues in the succeeding zone quanta, will continue from the same point defined at the zone quanta boundary. For example, in zone quanta 4 the path segments identified as B, D, F, G or H started at points defined on the near side horizontal boundary or the left side vertical boundary and shown in FIG. 14C as a blackened circle. Thus, path segments A, A′, C, C′ and E-E′ which originate in zone quanta 4 will continue in their respective adjacent zone quanta 7 and 8 along the heading toward their destination nodes A′, C′ and E′ respectively. Similarly, the path segments that began in zone quanta 3 and designated by start nodes F and G will continue through zone quanta 4 and into zone quanta 7 to destination F′, and into zone quanta 12 to destination G′ respectively. Further, the path segments that began in zone quanta 2 and designated by start nodes B and D will continue in zone quanta 4 to their respective destination nodes B′ and D′.

Referring now to FIG. 14E, there is shown an enlarged view of zone quanta 4 after the routing of each of the path segments has been completed including the paths being redirected around the obstacles that occur within zone quanta 4. Zone quanta 4 in FIG. 14E is again defined by the near side boundary 528, the left side boundary 530 and the zone quanta boundaries 532 and 534. Each of the path segments being routed are identified as in FIG. 14C by the capital letter designations indicating both the start node and the destination node. Thus, path segment A-A′ is routed as segment 552 between node A and the point defined on the zone quanta boundary 534 by the point 542. The heading for segment A-A′ within zone quanta 7 that has not yet been routed is indicated by the dashed line 554 which terminates at the destination node A′. Similarly, path segment B-B′ which begins from start node B on the near side horizontal boundary 528 and extends vertically away from the horizontal boundary 528 toward the destination node B′ designated by a triangle symbol at the end of the path segment 556.

Path segment C-C′ which originates within zone quanta 4, proceeds along segment 558 to a point 548 on zone quanta boundary 532 and will be completed to the destination node C′ as indicated by the dashed line between node 548 and node C′. Path segment D-D′ originates at start node D on horizontal boundary 528 and continues along segment 560 to destination node D′ at the triangle symbol within zone quanta 4. Path segment E-E′ extends vertically to the beginning of start node E within zone quanta 4 and proceeds along segment 562 to interim node 550 which is located on the horizontal zone quanta boundary 532 on a path heading extending into zone quanta 8 and terminating at node E′ within zone quanta 8.

Continuing with FIG. 14E, an example is provided for redirecting a routing path around several obstacles. Path segment F-F′ begins at start node F on left side vertical boundary 530 and is routed along segment 564 as far as it can go until encountering an obstacle in the form of path segment E-E′. The routing for segment F-F′ then proceeds through a redirection process and defines a pair of vias on either side of path E-E′ which enable the segment to be routed on the next adjacent routing surface layer as shown by segment 566. The path segment continues on the next layer and advances segment 568 to a node defined along the heading but enabling the router to redirect the path segment by jogging toward the near side horizontal boundary along path segment 570 to another node at which the router returns the path segment in the direction of the original heading as it redirects the routing path along segment 572 around the obstacle represented by segment C-C′. Upon bypassing this obstacle, the router defines another node and makes a turn or jog away from the near side horizontal boundary to another node along segment 574 which intersects with the original path heading. Thereupon the router defines a node and resumes the path segment advance along segment 576 toward the destination node F′ where it stops at point 546 which is defined at the zone quanta boundary 534. Thus, the routing of segment F-F′ illustrates two instances in which the routing engine 118 has successfully routed around the two obstacles represented by path segment E-E′ and path segment C-C′.

Similarly, the routing for segment G-G′ is subject to redirection as it is routed from the start node G along left vertical boundary 530 toward destination node G′ located in zone quanta 12. It is apparent that path segment G-G′ is required to define additional nodes along the original heading in order to redirect the path around obstacles represented by path E-E′ and D-D′ within zone quanta 4. These additional nodes locate points along the routing surface in which the path segment is jogged or changed in direction in order to bypass the obstacle. The routing path is then completed by the sequence of advancing path segments having with reference numbers 578, 580, 582, 584, 586, 588, 590, 592 and 594, until the path segment reaches the point 544 defined along advancing boundary 534. Path G-G′ will be completed during the routing of zone quanta 7 and zone quanta 12, as indicated by the dashed line connecting interim node 544 with destination node G′. Path segment H-H′ is routed in very straightforward fashion from the start node H along the left vertical boundary 530 along the path segment 596 to destination node H′ within zone quanta 4.

Referring now to FIG. 14F, an illustrative example is provided of a table of routing segments that could be used to define each segment for each zone quanta. It is one of several possible ways that the data for expressing the complete description of the routing path segment, including the node coordinates, could be defined. The left hand column is defined as the segments column which will be an ordinal number assigned to each path segment to be routed. The second column from the left is reserved for any segment that is to be routed in zone quanta 1. Similarly, the next column is for entering the segment data for path segments to be routed within zone quanta 2. Each zone quanta is represented by a single column through all of the zone quanta assigned to the particular circuit board being routed indicated by the subscript letter K to the symbol for a zone quanta z. The ordinal numbers for the segments column begin with N=1 and proceed through N segments for the entire circuit board including all of the routing surfaces. Further shown in FIG. 14F in the first segment entry for zone quanta 1 is a general expression for a path segment. In this expression, the symbol Lₙ indicates the ordinal number of the layer or particular routing surface of the set of surfaces that make up the complete circuit board as defined in the input data. Following the designation for the layer are the coordinates for the start node and the destination node of the path segment, respectively contained within parenthesis. Here, in each of the parenthesis, the x and y indicate the corresponding x and y terms coordinates for that particular node.

Continuing with FIG. 14F, there is shown a possible generalized form of the path segment expression that includes three sets of parentheses when of three nodes are required to define a particular path segment such as when an interim node is defined. The first set of parenthesis includes the coordinates for the start node designated as sₓ and s_{y}. The next pair of parenthesis includes the coordinates that could be defined for a point designated as iₓ and i_{y}. Similarly, the last pair of parenthesis includes the coordinates for a target node designated as tₓ and t_{y}. An alternative to the use of a point coordinate pair occupying an intermediate point along a segment is to assign node coordinates to the present node position and allow that coordinate pair to be updated as the segment approaches the destination node advance during the segment. Not shown in FIG. 14F but which will be apparent later during the description of FIG. 14G immediately following, is that a variation of the general expression for a path segment may include between nodes an R or an L or some other code to indicate that during the redirecting of a path segment, the routing engine 118 selected a branching path during the redirection relative to the original path heading.

In practice, the advancement of a portion of a segment within a zone quanta proceeds by adding a rectangle of a predetermined width corresponding to the etch width (or, generally the path width) and of a length corresponding to the amount of length added to the advancing end of the segment to reach a node or a zone boundary. The rectangle is specified by the start node coordinate and the target node coordinates. In effect, the rectangle may appear to grow in length until it reaches the target node. If an obstacle is encountered, the path jogs or branches as previously described.

FIG. 14G shows a portion of a table of routing segments for the segments routed in zone quanta 4 shown in FIG. 14E. FIG. 14G thus represents an example of the routing path segment data that may be entered in the table of the routing segments in the system database 106 representing each of the path segments that have been routed. This table is set up in the same way described for FIG. 14F. Each segment is assigned an ordinal number for the entire circuit board and for convenience in this example is also designated by the name given to the start node and destination node in the example of FIG. 14E. Similarly, each of the zone quanta is represented by one column of data which includes the path segments expression for each of the path segments which are routed within that particular zone quanta. For zone quanta 4 for example, the column labeled Z₄ lists all of the path segment coordinates which exist within zone quanta 4. Corresponding to each of the path segments identified by the letter designations A-A′, B-B′, C-C′ and so on, through the last segment to be discussed H-H′. The layer designations for most of the path segments in this illustrative example are on one layer, but for path segments F-F′, the layer designation is shown as an adjacent layer to accommodate the redirected path past the obstacle. Further in column Z₄, each of the coordinates for a start node or a destination node within the zone quanta 4 that are defined within parenthesis include a number corresponding to the position of the particular node relative to the near side or primary boundary and the left side or secondary boundary (and the y term), as measured in the units defined previously. Thus, the portion of path segment A-A′ that is routed within zone quanta 4 is designated as layer one with the start coordinate at horizontal position 8 and vertical position 3 and the destination coordinate, which is an interim node, located at horizontal position 10 and vertical position 3.

Continuing then in FIG. 14G, with path segment A-A′, the segment is defined from the interim node to the destination node at horizontal position 7 and vertical position 3, as indicated in the column for zone quanta 7. Similarly, through each of the path segments identified in zone quanta 4, an expression is given providing the designation of the layer and the coordinates for the start node and the destination node, respectively, within zone quanta 4 for each of the path segments. It will be appreciated that each of the path segments within zone quanta 4 and their continuing routing segments in the adjacent zone quanta are similarly expressed in the table shown in FIG. 14G and will not be further described herein.

Because of the orthogonalization of path segments performed by the analysis engine and the routing zone analysis performed by the routing zone controller in developing a routing plan, a frequent result may occur wherein a path segment may pass through a plurality of contiguous zone quanta in a substantially straight line if deviations of the routing path to avoid obstacles stay within the same zone quanta as the path segment being routed. Statistically, some obstacles will force the routing plan to cross zone quanta boundaries in directions lateral to the path heading. Nevertheless, a substantial number of path segments will approximate, within the dimensions of the zone quanta, the ideal straight line path from start node to destination node. An example of how this occurs is described with the aid of FIGS. 15A and 15B.

Reference is now made to FIG. 15A, wherein there is illustrated a portion of the routing surface of FIG. 14C, except that the planned path segment A-A′ has been extended from the start node in zone quanta 4 through a series of consecutive zone quanta 7, 12, 19 and 28 which includes the destination node A′. This set of zone quanta, designated by the reference number 600, is bounded by the near side horizontal boundary 602 and the left side vertical boundary 604. Similarly, the zone quanta shown in FIG. 15A are bounded by the far side horizontal boundary 606 and by the right side vertical boundary 608. The heading of path segment A-A′ through all of the zone quanta illustrated in FIG. 15A is indicated by the reference number 610. Immediately below the representation of the zone quanta for 7, 12, 19 and 28 is a table of path segment data representing for each zone quanta the particular coordinates of the path segment within that zone quanta. For example, opposite the designation Z₄ for zone quanta 4 is the expression for the path segment within zone quanta 4 that is given the expression for layer one with the start node coordinate 8, 3 in the first set of parenthesis and the interim node coordinate 103, which represents the end node for the path segment within zone quanta 4 along the boundary between zone quanta 4 and zone quanta 7. Similarly, for each of the zone quanta 7, 12, 19 and 28, are expressions for the path segment within each of those zone quanta. There will, of course, be deviations from this path within the boundaries of the zone quanta, through which the path segment A-A′ proceeds and this is illustrated in FIG. 15B. FIG. 15B illustrates a pair of contiguous zone quanta, in this particular example zone quanta 7 and 12, showing a representative portion of the routed segment A-A′ proceeding along the heading 610 through zone quanta 7 and 12 and bounded by the zone quanta boundaries.

Referring now to FIG. 15B, zone quanta 7 and 12 are bounded by the near side horizontal boundary 602 and on the opposite side by horizontal boundary 606. These are the two boundaries which may restrict the routing of the path segment A-A′ as it passes through these particular zone quanta along the heading 610 as long as no obstacles are encountered during routing which require the advancing path to pass into adjoining zone quanta. The routing of the path segment, because of hypothetical obstacles (not shown) within zone quanta 7 and 12, may advance as shown in the heavy line that begins at point 616 on the left vertical boundary of zone quanta 7 and proceeds to node 620 which is an offset node at which the routing engine 118 offsets or jogs the path to avoid an obstacle which is immediately along the heading 610. Thus, the path segment proceeds along the heavy line and through several additional nodes until it reaches the far side horizontal boundary at node 622 whereupon according to the rules previously described, the path segment advances to another node 624 along the boundary if not prevented from such path by an obstacle. This route then enables the routing engine 118 to return the routing segment path to the original heading at node 626. The routing path then advances along the original heading 610 until it encounters the zone boundary 614 that separates zone quanta 7 and 12. The path segment then crosses the boundary 614 at the point 628 and proceeds along the heading 610 toward the destination node at the point 632, which is located on boundary 616.

It will be appreciated in this illustrative example, that the routing of path segment A-A′ through zone quanta 7 and 12 has proceeded along a straight heading identified by the path heading line 610 even though it has deviated from that heading in several instances to avoid obstacles. However, the deviations may usually be small, when confined to the relatively small zone, see, e.g., segments F-F′ and G-G′ in FIG. 14. This result proceeds from the combined steps of orthogonalizing the net list paths, performing routing analysis before any routing is done, dividing the routing surfaces into relatively small zones and planning the routing/routing the plan by one zone quanta at a time. All segments between the origin (start) and destination or target nodes, though they may be separated by a span of several zones, are relatively straight headings which may be bounded by the boundaries of the row of zone quanta that includes the path segment. Thus, the process in the routing system and method of the present disclosure tends to efficiently find a suitable route between each pair of nodes. This result holds true for any number of layers, which are typically separated by a distance substantially less than the dimensions of a particular zone quanta because the homogenization process finds the minimum number of layers needed to route all of the path segments.

### The System Database

Referring now to FIG. 16, there is illustrated the structure of the system database 106 and its relationship with other structures in the routing system of the present disclosure. The system database 106 includes two major elements identified as the block 700 which represents the process to create a sandwich array, and a block 704 which represents the sandwich array itself. These two blocks 700 and 704 are connected by the data path 702. The source of data processed by the system database includes the neutral file 136 previously described. The data from the neutral file is accessed along data path 104 by the system database 106 as it creates the sandwich array in block 700. The other source for data entered into the sandwich array 704 is from the routing engine 118 along data path 122. Finally, the output 126 of the system database 106 is available on data path 124.

Continuing with FIG. 16, one aspect of the operation of the routing system of the present disclosure is that the particular data structure defined for the routing system must meet three criteria. The data structure must preferably store the data in a way related to the environment in which the data is generated, it must be structured in a such a way that both reading and writing of data into and from the database is possible at very rapid rates and the data structure must be easily indexed to facilitate both storage and access. These objectives are effective in resolving problems of high speed circuit board routing, which include first, how the system determines how not to run into components, terminals, routing paths and other structures on the routing surface and second, how to know exactly, in the entire environment of the circuit medium being routed, where the routing system is operating at any particular instant in time. It will be helpful to consider that a computer router lacks the visual sense of what is happening in the routing environment and therefore, must (a) depend entirely upon the data in the data structure and (b) be able to analyze the data rapidly in order to efficiently perform the complex path routing analysis required in the routing system of the present disclosure.

Thus, the preferred data structure illustrated generally in FIG. 16 is but one of several possible data structures that may be employed. One of the factors that will facilitate selection of a particular data structure is the fact that the routing system of the present disclosure may be characterized as the combination of both a gridless or shape based router wherein every feature is defined by its shape and, a gridded (bit-map) router that uses coordinates to define all of the locations of every feature on the surface being routed. A data structure which lends itself well to this particular routing system is one that accommodates the partitioning of the circuit board being routed into a set of sandwiches of a multi-layer board, wherein each sandwich comprises the set of slices, one layer per slice, placed side by side both horizontally and vertically, in the data structure to represent the entire circuit board. Each such sandwich may be thought of as somewhat like a core sample that is taken through layers of earth to enable analysis of each layer of the core sample, wherein each layer is represented by a slice in the core sample and each slice contains all of the information necessary to completely characterize the particular layer that it represents. In the data structure for the routing system of the present disclosure, each slice, which represents a unit area of a routing surface, is assigned to hold a maximum of three reference shapes, each of which defines a particular feature on that particular layer of the routing surface. Another way of describing the data structure, then, is that it represents a phase space that is continuous in two dimensions (the area represented by a slice) and discretized in the third dimension (the position on the slice of a particular feature). The maximum number of reference shapes is chosen to be three in the illustrative example, although it could be other values as well, in order to balance the amount of information contained within each slice of each sandwich with the processing speed that enables the most efficient routing. The greater the number of references in each slice, the slower is the analysis performed by the analysis engine and the routing zone controller 114. Similarly, the lower the number of references included within each slice of the data structure of each sandwich, the faster the analysis of that data may proceed in both the analysis engine 110 and the routing zone controller 114.

Continuing with the sandwich array data structure represented in FIG. 16, in order to add a feature in the data structure, the routing system must consider the following three factors. The first factor is to consider what slice in the data structure of a particular sandwich the feature that the routing system seeks to route cannot be placed in; that is, what features or obstructions already exist in the routing surface represented by that slice in that data sandwich that would preclude the routing of additional features. The second factor to consider is whether any of the routing features that were defined among the inputs to the routing system can be conveniently accommodated. The third factor which must be considered is whether any feature conflicts would arise in the particular slice. Assuming that the data structure can accommodate the addition of a feature and the data representing the additional feature is written to the data structure, the remaining issue that must be satisfied by the data structure is there must be a convenient and efficient index defined for the data structure. This index may essentially be a grid that identifies each of the slices in the sandwich array wherein each slice includes the data for the reference shapes used in routing the particular circuit paths.

### Accommodating Circuit Constraints

Many routing tasks require attention to certain specific constraints and other operational or manufacturing characteristics, for example, during routing to ensure optimum performance, manufacturability or to satisfy other considerations. Constraints may be thought of as rules governing the routing process through not only the analysis and path planning part of the process but also the actual routing of circuit paths. As will become apparent, routing constraints that apply during the analysis and planning parts of the process are called logical routing constraints, to distinguish them from the constraints applicable during the actual routing, which are called physical routing constraints. Constraints may be provided in a given application, for example, with respect to the time delay of a signal path, the crosstalk between an aggressor path and a victim path, the electromagnetic radiation from a circuit or its susceptibility to interference, whether a routed circuit can be reproduced in automated mass production processes without defects, whether a completed path routing has maximized the utilization of the available routing surface, and so forth.

To illustrate how the system of the present disclosure can accommodate such constraints, the descriptions of FIGS. 18, 19 and 20 set forth hereinbelow provide an example of the planning and routing processes to accommodate predetermined time delay and crosstalk constraints. Some of the objectives that may be achieved by the planning and routing system of the present disclosure include: (1) produce a completed circuit routing design that satisfies all predetermined constraints for time delay and crosstalk; (2) accomplish (1) without increasing the routing surface size or, at least, without leaving un-utilized routing surface; (3) verify a routed circuit during the routing process for its performance without having to wait for actual testing of a fully routed or assembled circuit; (4) make use of third party tools for analysis and design to customize the automated routing system to the needs of individual customers or applications; or (5) minimize the amount of revision to a completed circuit routing design.

These and other objectives may be achieved in the automated routing system of the present disclosure in the following ways: (1) convert an electrical specification or logical parameter of the circuit to a physical parameter of the routing surface, e.g., time delay to path length, or crosstalk to path spacing; (2) selectively use external third party tools in an iteration loop or feedback path during routing path analysis and/or during path routing and including a modify step as necessary; (3) adopt minimum spacing as a constraint during pre-planning of each unit zone and/or homogenizing the path densities; (4) provide an open system with interfaces to third party tools that enable and perform constraint processing and verification; (5) perform verifications during both path analysis and routing for small unit zones at a time to rapidly and efficiently produce a routed circuit that is very close to the desired result; and (6) perform the path analysis and routing of the most difficult paths first (e.g., paths having constraints or paths of greatest length) when the surface is least crowded.

In the descriptions to follow, as an illustrative example, time delay for a signal path may be converted to a path length by estimating a length value that should provide the desired delay time for a given trace configuration, taking into account such factors as velocity of propagation or other transmission line parameters. The length value is then entered into an iterative process of planning the route, and correcting its value in a feedback loop that may utilize a third party tool during the analysis process. As another illustrative example, a required crosstalk specification may similarly be converted to an average estimated spacing between the aggressor and victim paths, likewise analyzed in the iterative loop that may utilize feedback from a third party tool during the analysis process to plan the route. Then, during the routing process the crosstalk result is checked, again by using the third party tool, to verify and correct the path routing during the routing process.

The approach described hereinabove may be used for a variety of circuit requirements just by defining the requirement so it can be expressed in terms of a physical parameter of the circuit board or routing surface. The analysis and routing processes can then proceed, calling on third party tools via interfaces to them as necessary to process specific analysis data or verify a path routing result. The process is iterative, employing feedback to arrive at a satisfactory circuit path routing. Some unary (i.e., having a single aspect) circuit requirements, which involve primarily the path being processed itself, such as time delay or electromagnetic interference (EMI) are processed effectively during the analysis phase. Other requirements requiring verification, which involve so-called binary considerations—the relationship of one path with another, neighboring path, such as crosstalk or manufacturability considerations, receive additional processing during the routing phase. These techniques are especially effective in the routing system of the present disclosure because of the inherent advantage of analyzing and routing all the paths together, within one small unit zone at a time, that results in satisfying all the requirements and constraints together. This approach minimizes the amount of post-processing and re-routing. Further, since all of the analysis and routing is performed on a computer, or, alternatively on several computers for large projects, it is accomplished very fast compared to the traditional or manual routing systems.

Referring now to FIG. 17, there is illustrated a simplified flow diagram of an alternate embodiment of the operation of the analysis engine of the present disclosure. Before beginning the description of FIG. 17, which in part operates according to a trace creating algorithm, it will be helpful to define what is meant by a trace creating algorithm. It is well known that an algorithm is a set of specified sequential steps for performing a given operation. An algorithm typically operates on information provided at the outset which may include input data. In addition, an algorithm may operate according to specific rules in different steps of the algorithm. As will become clear herein below, the trace creating algorithm may refer either to the steps of the process or it may also refer to the steps of the process and any input data and/or additional rules that are utilized during the process steps.

Referring now to FIG. 17 which illustrates a simplified flowchart of a method of planning the routing of circuit paths, the flow begins at the Start block 720 and proceeds to step 722 to provide input data for the connections of the routing paths that will be planned during the operation of the analysis engine of the present disclosure. Subsequent to providing input data, there is provided in step 724 an opportunity to specify constraints affecting the routing, that is, specifying any routing constraints or rules for accommodating particular operational characteristics of the circuit that is being routed. The flow continues to step 726 wherein the system creates a portion of the pattern of traces according to a trace creating algorithm. In the following step, step 728, after creating the pattern of traces, the system analyzes the created paths subject to any routing constraints that may apply to a particular trace among the pattern of traces created. From step 728, the flow proceeds to step 730 wherein the system compares the result of analyzing the paths with the routing constraint specification for the paths being analyzed. After the comparison step 730, the flow proceeds to a decision block 732 wherein the system seeks to determine whether the specification for the routing constraint has been satisfied. If the answer is affirmative, the flow follows the “Y” path to step 734 wherein the system advances to the next connections to be routed on the routing surface. Following step 734, another decision block 736 determines whether all traces have been created and if the answer is affirmative, then the flow follows the “Y” path and ends at step 738. If, however, the determination is made that all traces have not been created, then the flow proceeds along the “N” path to the start of the flow diagram and reenters step 722. Returning to step 732, if it was determined that the routing constraint specification was not satisfied by the created traces, then the flow follows the “N” path to decision block 742.

Continuing with FIG. 17, a step 740 is shown within dashed lines, step 740 being captioned: “revising the trace creating algorithm,” which includes a number of substeps relating a particular action taken by the analysis engine affecting the trace creating algorithm. In general, if the routing constraint specification was not satisfied, then the trace creating algorithm may be revised by modifying some aspect of the trace creating algorithm as shown in FIG. 17 within the dashed line of step 740. Thus, in step 742, the system seeks to determine whether the input data to the analysis engine needs to be modified. If the answer is affirmative, then the flow follows the “Y” path to step 744 to perform the modification to the input data prior to repeating or iterating the process for planning of circuit paths and the flow from step 744 then reenters step 722. If, however, in step 742 the input data do not need to be modified, then the flow follows the “N” path to another decision step 746 to determine whether the routing constraint itself needs to be modified. If the determination is made that the routing constraint does need to be modified, then the flow follows the “Y” path to step 748 to modify the routing constraint and the result of step 748 is to return to step 724 to be included in the step for specifying constraints that affect the routing. Returning to step 746, if it was determined that the routing constraint does not need to be modified, then the flow follows the “N” path to step 750 to modify the trace creating algorithm. Thereafter, the flow proceeds to step 726 in which the creation of the pattern of traces will be performed according to the modified trace creating algorithm.

To better understand the operation of the planning process illustrated in FIG. 17, it will be helpful to consider the steps of the main path of the process in three different groups. In the first group, including steps 722 and 724, the input data and routing constraints affecting particular operating characteristics of the circuit paths to be created are specified and provided for use by the analysis engine in operating according to the trace creating algorithm. In the second group, step 726 represents the main task of the process to create a pattern of traces utilizing a trace creating algorithm that governs the operation of the analysis engine in the system of the present disclosure. In the third group of steps, which includes step 728, 730 and 732, the system operates to check its work by analyzing the paths subject to any routing constraints. This analysis includes the comparison of the result of the created paths as to a particular operating characteristic with a specification for the routing constraint that affects that operating characteristic. Then, in step 732, two possible outcomes are provided. One advances to the next connections to be routed through all of the traces remaining to be created as previously described. The other outcome, which follows when a discrepancy is found between the routing constraint and the particular specification for the routing constraint, is performed in a feedback loop to revise the trace creating algorithm in some way to achieve a closer match between the specified routing constraint during the analysis of the resulting path that is affected by the routing constraint.

As previously described, routing constraints are rules which define the required result for particular operating characteristics in the circuit being routed. For example, a particular trace or particular group of traces may be required to meet a predetermined specification for the amount of time it takes for a signal to traverse the particular trace. Such a specification would be in terms of the time delay for that trace and is illustrated hereinabove with FIG. 7H. As another example, a specification may exist for the amount of crosstalk from one trace along the routing surface into a neighboring trace along the routing surface, e.g., the crosstalk that occurs between the one trace called the aggressor trace, and the neighboring trace called the victim trace. Such a specification arises when it is of concern that the amount of signal coupled from the aggressor trace must be below a threshold level as measured in the victim trace and would be necessary to prevent degradation of any signal traveling in the victim trace by the signal flowing in a neighboring aggressor trace. For either of these operational characteristics then, a routing constraint could be applied during the operation of the trace creating algorithm in order to develop a routing plan that provides circuit paths or traces that meet the electrical specifications for the circuit being routed. Thus the trace creating algorithm includes routing constraint rules within it provided to accommodate these particular performance restrictions placed upon the routing of the circuit traces. Not shown in FIG. 17, but to be described in detail later in conjunction with FIGS. 18, 19 and 20, the steps 728, 730, and 732 shown in FIG. 17 may include branching steps to third party tools accessed by the analysis engine to perform particular processing according to a routing constraint. Moreover, the step 726 for creating a portion of the pattern of traces according to a trace creating algorithm may include a number of substeps further detailing the particular operation of the step 726. The description to follow for FIGS. 18, 19 and 20 will describe an embodiment that includes further detail of the creation of a pattern of traces according to a trace creating algorithm.

Referring now to FIG. 18, there is illustrated a first portion of a flow diagram of an alternate embodiment of the operation of the analysis engine of the present disclosure. Beginning with the Start 800 step, the flow proceeds to step 802 to input connection data for processing. The next step is a decision step 804 to determine whether the connection data is associated with a constraint. If a constraint is not associated, the flow follows the “N” path to step 806 to insert the connection data in a queue and the flow thereupon proceeds back to the input of step 802. If the connection data is associated with the constraint, the flow follows the “Y” path to step 808 to input the constraint, which step is followed by step 810 to define the topology of the circuit path routing.

In step 810, the topology may be defined in a number of different ways, a few of which are illustrated within the block defining step 810. The topology may be user defined, user guided, it may be defined in terms of standard patterns, it may be defined according to a minimum spanning tree configuration, or other topology arrangements such as daisy chaining or node ordering may be employed in the definition of the topology to be used in analyzing the routing of the circuit paths. In the above list of topology rules a user defined rule is one in which a particular connection is fully or partially specified at the outset; that is, the connection must be made between specifically identified terminals or nodes. Similarly, user guided rules specify some aspect of the connection to be made but do not express it in mandatory terms that it must be made in a specific way. A topology configured according to standard patterns means to make connections according to standard configurations which are found repetitively such as illustrated in FIG. 7 hereinabove. The minimum spanning tree (MST) topology has also already been described hereinabove.

Continuing with FIG. 18, the flow from step 810 proceeds to decision step 812 to make a determination whether any patterns have been found in the topology as defined in step 810. If the result of this determination is affirmative, then the flow proceeds to step 814 to assign a segment template from a pattern library before returning to the main path at the input to step 816. If in step 812 the determination is made that there are no patterns found in the defined topology, then the flow is along the “N” path to step 816 to compute tile densities from existing obstacles in patterns. It will be appreciated that step 816 resembles step 216 of FIG. 4 described hereinabove. The flow then proceeds to step 818 to sort connections according first to connections having associated constraints and second, to connections without associated constraints. The actual criteria for sorting connections may of course vary depending on the application.

Once the connections have been sorted into an order in which they will be analyzed and/or routed, the flow proceeds to step 820 to iterate through all the connections with logical constraints for path planning. Constraints are rules used to determine how a particular circuit path will be routed and may include, for example if/then statements to express such requirements as the length of a path or the amount of delay time allowed along a particular path, etc. Constraints that are processed during the analysis phase are referred to as logical constraints because they express circuit specifications that are associated with particular connections. Later on, as the actual routing processes, constraints that will be associated therein will be referred to as physical constraints because at that point in the process the constraints are expressed in terms of physical parameters of the routing surface as will become clear hereinbelow.

Continuing further with FIG. 18, the flow proceeds to step 822 to create the path under consideration using both density data and the logical constraints that are associated with the particular connection being processed. In step 822, the creation of a path may proceed much in the same way as the analysis illustrated and described in conjunction with FIG. 4 hereinabove, for example, including the steps “collapse the segments” and “orthogonalize the segments,” respectively steps 208 and 212 shown in FIG. 4. During the path creation process that begins with step 822 in those cases that need to accommodate various requirements or constraints, a provision for interacting with a third party tool in order to accomplish specific analysis operations regarding specific requirements or constraints may be required.

Referring now to FIG. 19 the process flows from step 822 along a path identified with an encircled letter A to a decision block 824 which provides for branching to a third party tool via a third party interface manager. The entry into, for example, a branch routine to accomplish a verification process is provided by decision step 824 which determines whether to call a third party tool for the verification process. If the result is affirmative, then the flow proceeds along the “Y” path to step 826 to engage the third party interface manager which serves as an interface between the analysis process of the present disclosure and a third party tool which can be accessed and respond as represented by step 828. The response to the operation of the third party tool 828 then is provided by the third party interface manager 826 to return to the main process flow at the input to decision step 830. If, in step 824, there is not a need to call a third party tool for verification, then the flow proceeds along the “N” path to step 830 where another decision step seeks to determine whether all of the constraints thus far have been met. If the result of that determination is negative, then the flow follows the “N” path and returns to the input to step 822 to repeat step 822 as described hereinabove. Returning to step 830, if the determination was made that the constraints are in fact met, then the flow proceeds along the “Y” path to step 832 to add the circuit path that has been analyzed and planned to the density data which completes the analysis for that particular path.

Continuing with FIG. 19, the flow proceeds to step 834 and a determination is made as to whether there are any more connections with constraints that need to be routed. If the result of that determination is affirmative, then the flow proceeds along the “Y” path, also identified with an encircled letter D, to return to the input to step 822 in FIG. 18. If the determination of step 834 is negative, then the flow proceeds to step 836 where the process continues to iterate through the remaining connections to be planned during this analysis. Thereupon the flow proceeds to step 838 to create paths using the density data, which step is again similar to step 822 in that it proceeds much as the analysis steps illustrated in FIG. 4 hereinabove. It will be appreciated at this point that steps 836 and 838 represent the creation of paths for connections that do not have associated routing constraints. Upon creation of these paths, the flow proceeds to decision step 840 wherein a determination is made as to whether the homogenization of the created paths is adequate; if the result is negative then the flow proceeds to another decision step 842 to determine whether it is necessary to retry all of the connections. If the result of that determination is negative, then the flow proceeds back to the input of step 836 to iterate the most recently created path to create a path in which the homogenization will be found to be adequate. If, in step 842, it is found necessary to retry all connections, then the flow proceeds along the “Y” path, also identified by an encircled letter C, back to FIG. 18 to the input to step 820 where the process iterates through connections with logical constraints for path planning. In other words, the paths identified in the step 840, which sought to determine whether the homogenization is adequate, are selected for repeating the analysis process by beginning again with the step 820, iterating through the connections having logical constraints.

Returning to FIG. 19 and step 840 wherein the homogenization is determined to be adequate, the flow proceeds therefrom along the “Y” path to the input of a decision step 844 to determine whether there are any connections remaining in the queue. If the result of this determination in step 844 is affirmative then the flow proceeds along the “Y” path, also identified with an encircled letter B, to FIG. 18 to a step 846 to input the next connection data from the queue into the input to step 810 to define the topology for that next connection. Returning to FIG. 19 in step 844, if there are no connections remaining in the queue, then the flow proceeds along the “N” path to step 848 to transfer the path data to the optimized segments file. At that point, the analysis process is completed for a particular unit zone as described hereinabove and is so signified by the End block 850.

Referring now to FIG. 20, there is illustrated a flow diagram of an alternate embodiment of the operation of the routing engine of the present disclosure. FIG. 20 is essentially a modification to FIG. 13B which was previously described hereinabove and represents a modification to accommodate the processing of constraints associated with connections to be routed, including interfacing of the process on specific need to select third party tools to perform verification of constraint requirements or other processing steps during the routing engine operation. The process takes up in step 902, analogous to step 440 in FIG. 13B and which is a decision step which seeks to determine whether the particular zone being routed has been completed; if the result is negative, then the flow proceeds along the “N” path, also identified by encircled letter B, to FIG. 13A to step 418 to retrieve the next segment and advance the pointer as previously described for FIG. 13A hereinabove. However, if the zone is complete, then the flow proceeds from step 902 along the “Y” path to step 904 to initiate a first verification of a particular constraint that applies to the connection being routed. The flow then proceeds to decision step 906 to determine whether to call a third party tool for the verification to take place; if the decision is affirmative, then the flow proceeds along the “Y” path to step 908 to engage the third party tool interface manager which interacts with the third party tool 910 to perform the required processing. Upon completion of the processing by third party tool 910, the flow proceeds from step 908 to the input to the next step 912 to evaluate the constraint compliance. Returning to step 906, if the determination was made that it is not necessary to call the third party tool for verification, the flow proceeds along the “N” path to step 912 to evaluate the constraint compliance. Step 912 performs an internal verification which is useful particularly if no third party tool was called in the proceeding steps, to ensure that all constraints are in fact complied with and that an opportunity to modify the constraint set if necessary in step 914 may be provided to ensure that no constraint will go unchecked during the routing process before the routing engine advances to the next zone in step 916.

Following the advance to the next zone in step 916 where the routing engine starts over with the routing of circuit paths, the flow proceeds to step 918 which makes a determination as to whether the first and second zone boundaries are fully advanced. If the result is negative, then the flow proceeds along the “N” path identified with an encircled letter A to FIG. 13A to step 474 to do the routing zone analysis for the next zone. The routing zone analysis has been previously described in conjunction with FIGS. 18 and 19. Returning to step 918 on FIG. 20, if the determination has been made that both the first and second zone boundaries are fully advanced then the flow proceeds to the “Y” path to step 920 to transfer the routing connections to the system database. When the routing connections have been transferred to the system database, a flag is set indicating that the routing is complete in step 922. Setting the flag is followed by step 924 to initiate a final verification of the routing for the entire routing surface just completed. It will be appreciated at this point that some discrepancies may remain between the resulting routing as completed and the desired routing that was intended at the outset. This is provided for in step 926 which is a determination step that seeks to determine whether to call the third party tool for a verification process by a particular third party tool; if the result is affirmative then the flow proceeds along the “Y” path to step 928 to again engage the third party tool interface manager which interacts with the third party tool 930 to re-verify a routed circuit path that was selected for final verification. Upon the completion of the verification, the flow proceeds from the third party tool interface manager in step 928 to the input to step 932 where a determination is made as to whether the final verification is indeed OK. If the result of that step 932 is negative, then the flow proceeds along the “N” path, also identified as the encircled letter B, to the input of step 418 in FIG. 13A. If the final verification determination is affirmative, then the flow proceeds from step 932 to end the routine at step 934.

To summarize, the routing system and method of the present disclosure provides extensive up front analysis performed by the routing system upon the input data defining the circuit board or other medium to be routed. The input data includes a placement diagram, a net list and geometrical, mechanical and other parameters of the circuit medium as well as other circuit and electrical constraints. Circuit paths are characterized as routing segments which are defined by endpoints or nodes. Nodes may be fixed in position, as specified in the input data or variable in position as specified by the routing system. The up front analysis includes tasks performed by the analysis engine 110, such as the minimum spanning tree analysis, the orthogonalization of segment paths, the homogenization of routing segment paths and the pattern recognition performed at several points in the process.

A second feature of the present routing system and method is the reduction of the entire surface area to be routed into, generally uniform, small zone quanta, which directly reduces the complexity of routing within each zone quanta, as the routing zone controller 114 further analyzes the routing data and constraints as it develops the routing plan. A third feature provided is the coordinated, rapid, systematic advance through the array of zone quanta along with the ordering of nodes and segments in the routing plan, which performs the routing for each zone quanta as the routing zone analysis or routing plan is completed for each zone. Thus, through the combination of thorough, systematic path and routing analysis and organizing the processing of the routing surfaces as the systematic advance through a large number of small zone quanta, the complex path routing tasks are reduced to much simpler ones performed at very high speed by one or a plurality of conventional computers resulting in about one order of magnitude improvement in path routing processing speed. A fourth feature of the present routing system is the use of a sandwich array or other data structure optimized for storing data in a way that easily relates to positioning specific locations within a defined area and facilitates the storage and the accessibility of the data to and from the database.

A fifth feature of the present routing system is the ability to accommodate various specific circuit requirements and constraints during the analysis process of planning a circuit routing and the actual routing of the circuit paths by interfacing with third party tools as necessary in iterative processes that employ feedback to satisfy the requirements and constraints. For example, time delay, electromagnetic compatibility, manufacturability and crosstalk are several illustrative examples of requirements and constraints that may be satisfied.

Although the preferred embodiment has been described in detail, it should be understood that various changes, substitutions and alterations can be made therein without departing from the spirit and scope of the invention as defined by the appended claims.

What is claimed is:

1. A method for planning the routing of circuit paths on at least one routing surface, comprising the steps of:
defining a topology of the circuit paths on the routing surface according to input data for connections to be routed and respective routing constraints associated with the connections to be routed;
creating the circuit paths for connections to be routed having associated routing constraints, iteratively within each one of a plurality of predetermined unit zones of the at least one routing surface wherein the plurality of predetermined unit zones are processed in a predetermined sequence, the circuit paths being created according to the defined topology of the circuit paths within each unit zone;
verifying the circuit paths created, by evaluating the circuit paths for compliance with the respective routing constraints associated with the connections to be routed, during the step of creating the circuit paths; and
saving data describing the circuit paths created for the at least one routing surface.

2. The method of claim 1, further comprising the step of:
providing results of verifying the circuit paths via feedback preceding the step of creating the circuit paths.

3. The method of claim 1, wherein the step of defining a topology comprises the step of:
selecting at least one of a rule for defining the topology from the group including user-defined rule, user-guided rule, standard pattern rule, minimum spanning tree (MST), daisy chain and node ordering;
computing densities of circuit paths to be routed from known obstacles and path patterns;
sorting the connections to be routed in order first for connections to be routed that are associated with a routing constraint and second for connections to be routed that are not associated with a routing constraint; and
planning circuit paths to be routed in order within each unit zone.

4. The method of claim 1, wherein the step of creating the circuit paths comprises the steps of:
reducing the circuit paths to orthogonal components;
defining a circuit path to comply with path density data and routing constraints;
performing a constraint verification on the defined circuit path; and
if the result of the constraint verification is negative, repeating the step of creating the circuit paths.

5. The method of claim 1, wherein the step of creating the circuit paths comprises the steps of:
reducing the circuit paths to orthogonal components;
defining a circuit path to comply with path density data and routing constraints;
performing a constraint verification on the defined circuit path; and
if the result of the constraint verification is affirmative, proceeding with a next connection to be routed.

6. The method of claim 1, further comprising the step of:
creating the circuit paths for connections to be routed that do not have associated routing constraints.

7. The method of claim 1, further comprising the step of:
determining whether homogenization of circuit paths routed in adequate.

8. The method of claim 7, wherein the step of determining comprises the step of:
iterating the connections previously routed in the unit zone if the homogenization is not adequate.

9. The method of claim 7, wherein the step of determining comprises the step of:
iterating the connections to be routed in the unit zone if the homogenization is adequate.

10. The method of claim 1, wherein the step of verifying the circuit paths comprises the step of:
accessing a dedicated processing module via an interface manager to perform a constraint verification according to the routing constraint associated with the connection to be routed that is being created.

11. The method of claim 1, wherein the step of verifying the circuit paths comprises the steps of:
accessing a processing module via an interface manager, the processing module configured for verifying the routing constraint associated with the connection to be routed; and
verifying the routing constraint is satisfied.

12. A method for automatically routing circuit paths on at least one routing surface, comprising the steps of:
planning the routing of the circuit paths on the at least one routing surface to produce a routing plan;
activating a routing engine to begin processing circuit path data retrieved from a routable segments file from an origin to an ultimate location and in incremental steps within each of a plurality of unit zones in sequence defined for the at least one routing surface to define an expanding virtual map of the routing plan such that all of the circuit paths defined by the routing plan between the origin and the extremities of the expanding virtual map are created;
verifying, upon the completion of routing the circuit paths of each unit zone, that any routing constraint associated with a connection to be routed in the present unit zone in the routing plan satisfies the associated routing constraint;
modifying the circuit path routing in the present unit zone if a routing constraint associated with a connection being verified in the previous step in the present unit zone does not satisfy the associated routing constraint; and
advancing to the next unit zone.

13. The method of claim 12, wherein the step of planning the routing of the circuit paths comprises the steps of:
defining a topology of the circuit paths on the routing surface according to input data for connections to be routed and respective routing constraints associated with the connections to be routed;
creating the circuit paths for connections to be routed having associated routing constraints, iteratively within each one of a plurality of predetermined unit zones of the at least one routing surface wherein the plurality of predetermined unit zones are processed in a predetermined sequence, the circuit paths being created according to the defined topology of the circuit paths within each unit zone;
verifying the circuit paths created, by evaluating the circuit paths for compliance with the respective routing constraints associated with the connections to be routed, during the step of creating the circuit paths, and
saving data describing the circuit paths created for the at least one routing surface.

14. The method of claim 12, further comprising the step of:
initiating a final verification, after routing of all of the circuit paths in all of the unit zones is completed, that all routing constraints associated with a connection to be routed are satisfied.

15. The method of claim 12, wherein the step of verifying comprises the steps of:
accessing a processing module via an interface manager, the processing module configured for verifying the routing constraint associated with the connection to be routed; and
verifying the routing constraint is satisfied.

16. A method for planning the routing of circuit paths on at least one defined routing surface to accommodate a predetermined circuit parameter affecting the routing, comprising the steps of:
converting the predetermined circuit parameter affecting the routing of circuit paths to a spatial parameter of the at least one defined routing surface to be routed;
estimating the spatial parameter value required to satisfy the predetermined circuit parameter;
performing an iterative routing path analysis within each one of a plurality of predetermined unit zones of the at least one routing surface, wherein the plurality of predetermined unit zones are analyzed in a predetermined sequence to create a routable circuit path according to a defined topology of the circuit paths with each unit zone, and according to the estimated spatial parameter value;
evaluating the routable circuit path in a processing module, the processing module being configured to determine the correct circuit parameter value for the routable circuit path in a present unit zone, and expressing it in terms o the spatial parameter, the processing module further being accessible via an interface manager;
feeding back information indicating whether the circuit path as created satisfies the required circuit parameter value; and
iterating the routing path analysis until the circuit parameter value is met.

17. A method for planning the routing of circuit paths on at least one routing surface, comprising the steps of:
creating a pattern of traces on a routing surface from input data for connections in accordance with a trace creating algorithm;
after creating less than all of the pattern of traces, analyzing an operational characteristic of the created portion of the pattern of traces in the operating environment of the trace including traces subject to predetermined routing constraints;
comparing results of the analyzing step to a specification for the 10 operational characteristic of the created portion of the pattern of traces;
modifying the trace creating algorithm if the operational characteristic fails to satisfy the specification; and
repeating the foregoing steps until the operational characteristic for the created traces in the portion of the pattern of traces created satisfies the specification.

18. The method of claim 17, wherein the step of creating comprises the steps of:
expressing the predetermined routing constraints as physical parameters of the routing surface;
defining the topology of the pattern of traces to be used during the planning of the routing of circuit paths; and
creating the pattern of traces utilizing the input data, predetermined routing constraints and the topology of the pattern of traces.

19. The method of claim 17, wherein the step of analyzing comprises the step of:
branching to an analysis routine to verify the operational characteristic of the created portion of the pattern of traces; and
running a verification analysis to produce a value of the operational characteristic for comparison.

20. The method of claim 17, wherein the step of comparing comprises the step of:
retrieving the specification for the operational characteristic; and
comparing the produced value of the operational characteristic with the specification.

21. The method of claim 17, further comprising the step of:
advancing to the connections for the next portion of the routing surface for which the routing of circuit paths is to be planned; and
repeating the steps of claim 17 until the planning the routing for all portions of the routing surface is completed.
